(19) United States
(12) Patent Application Publication
(10) Pub. No.: US 2026/0070280 A1
(43) Pub. Date: Mar. 12, 2026

(54) POLYMER SUITABLE FOR ADDITIVE MANUFACTURING

(71) Applicant: Poly-Med, Inc., Anderson, SC (US)

(72) Inventors: Michael Scott Taylor, Anderson, SC (US); Brian Gaerke, Anderson, SC (US); Michael Aaron Vaughn, Anderson, SC (US)

(21) Appl. No.: 19/387,980

(22) Filed: Nov. 13, 2025

Related U.S. Application Data
(63) Continuation of application No. 17/436,312.
(60) Provisional application No. 62/814,777, filed on Mar. 6, 2019.

(51) Int. Cl. B29C 64/118; B33Y 10/00; B33Y 30/00; B33Y 40/10; B33Y 70/00; D01F 6/62; D01F 6/84

(52) U.S. Cl. CPC B29C 64/118; B33Y 10/00; B33Y 40/10; B33Y 70/00; D01F 6/625; D01F 6/84; B33Y 30/00

(57) ABSTRACT

Polymers and formulated compositions are designed to have properties that allow their effective use in additive manufacturing processes, particularly for preparing articles wherein molten monofilament polymer is laid down on top of a previously deposited line of molten monofilament polymer.

### CROSS-REFERENCE TO RELATED APPLICATION

This application is a continuation of U.S. application Ser. No. 17/436,312 filed Sep. 3, 2021, which is a national phase application filed under 35 U.S.C. § 371 of International Application No. PCT/US2020/021499 filed Mar. 6, 2020, which claims the benefit under 35 U.S.C. § 119(e) of U.S. Provisional Patent Application No. 62/814,777 filed Mar. 6, 2019, each of which is hereby incorporated herein by reference in its entirety.

### FIELD OF THE DISCLOSURE

The present disclosure relates generally to additive printing, polymeric compositions for use therein and products made thereby, including bioabsorbable polymers for medical uses.

### BACKGROUND

Additive manufacturing, also known as 3D printing, has developed from curiosity to industrial process over the past twenty years, mostly through advancements in equipment and computer software. While the ability to create advanced structures has improved, there exists a need for improved, multifunctional materials to support this growing technology.

One popular method of additive manufacturing is fused filament fabrication (FFF). The majority of additive manufacturing through FFF utilizes a single-phase thermoplastic polymeric monofilament to generate a print line through melt extrusion. The print line is in a horizontal plane, which may be referred to as a plane in the x-y direction, and that x-y plane may contain independent multiple print lines, depending on the desired design of the article. Sometime, multiple articles are printed at the same time, in which case multiple first print lines area laid down in a single (first) x-y plane. In order to create a 3-dimensional article, i.e., in order to create an article having a z-direction, one or more second print lines are laid down in a second x-y plane that sits on top of the first x-y plane defined by the location of the first print line(s). The height of the printing, i.e., the extent of z-direction, is defined by the number of x-y planes that are printed on top of one another.

After the article(s) is printed, it may be tested for how strong it is, that is, how much force is required to break or crack the printed article. When such testing is performed, it is often noted that the strength in the x-y direction is greater than the strength in the z-direction. In other words, it is much easier to break the connections between the first plane and the second plane, compared to the force needed to break a particular x-y plane. The printed articles thus exhibit asymmetry strength, which is typically undesirable.

There thus remains a need in the art for improved materials that may be used in additive manufacturing, particularly in the manufacture of articles having reduced asymmetric strength. The present invention is directed to addressing this need.

All of the subject matter discussed in the Background section is not necessarily prior art and should not be assumed to be prior art merely as a result of its discussion in the Background section. Along these lines, any recognition of problems in the prior art discussed in the Background section or associated with such subject matter should not be treated as prior art unless expressly stated to be prior art. Instead, the discussion of any subject matter in the Background section should be treated as part of the inventor's approach to the particular problem, which in and of itself may also be inventive.

### SUMMARY

In brief, the present disclosure provides compositions useful in additive manufacturing, methods of conducting additive manufacturing that make use of the compositions of the present disclosure, and products made by the additive manufacturing process, and related subjects. Polymers and formulated compositions are designed to have properties that allow their effective use in additive manufacturing processes, particularly for preparing articles wherein molten monofilament polymer is laid down on top of a previously deposited line of molten monofilament polymer.

In one embodiment, the present disclosure provides a monofilament fiber comprising a polyaxial polymer of a formula M(B)₂ or M(B)₃, where M comprises repeating units and B comprises repeating units. In the polyaxial polymer, a majority of the repeating units in M are the polymerization residues from TMC and/or CAP and a minority of the repeating units in M are the polymerization residues from LAC and/or GLY, while in contrast, a majority of the repeating units in B are the polymerization residues from GLY and/or LAC and a minority of the repeating units in B are the polymerization residues from TMC and/or CAP. In this way, the mid-block M has properties resulting primarily from the presence of residues of TMC and/or CAP, influenced by a minor amount of the residues from LAC and/or GLY, while the end grafts B have properties resulting primarily from the presence of residues of LAC and/or GLY, influenced by a minor amount of the residues from TMC and/or CAP. Optionally, M comprises repeating units from both of TMC and CAP, so that M is a copolymer comprising a majority of a mixture of CAP and TMC residues as repeating units, as well as GLY and/or LAC derived repeating units as a minor proportion of the repeating units.

For example, the present disclosure provides monofilament fiber comprising a polyaxial polymer of a formula M(B)₂ or M(B)₃, where M may be a homopolymer or a copolymer, and comprises a plurality of repeating units, where at least 50 mol %, e.g., 70 mol %, of the repeating units in M are a polymerization product of at least one of trimethylene carbonate and epsilon-caprolactone; and B may be a homopolymer or a copolymer, and comprises a plurality of repeating units, where at least 50 mol %, e.g., 70 mol %, of the repeating units in B are a polymerization product of at least one of glycolide and lactide, and optionally both of glycolide and lactide In one embodiment, M is a copolymer. The present disclosure also provides an assembly comprising a monofilament fiber wound around a spool, the monofilament fiber comprising a polyaxial polymer of a formula M(B)₂ or M(B)₃, where M is a homopolymer or a copolymer and comprises a plurality of repeating units from first monomer polymerization, where at least 50 mol %, e.g., 70 mol %, of the repeating units in M are a polymerization product of at least one of trimethylene carbonate and epsilon-caprolactone i.e., the first monomer is TMC and/or CAP, and optionally includes at least two monomers, e.g., TMC and CAP, or TMC and CAP and LAC, or TMC and CAP and GLY, in order to provide for a copolymeric M, and B is a homopolymer or a copolymer and comprises a plurality of repeating units from second monomer polymerization, where at least 50 mol %, e.g., 70 mol % of the repeating units in B are a polymerization product of at least one of glycolide and lactide (i.e., the second monomer is selected from LAC and GLY, and may be optionally be a mixture of the polymerization residues of LAC and GLY, optionally a mixture thereof). The present disclosure also provides a kit, the kit comprising an assembly inside of a pouch, the assembly comprising a monofilament fiber wound around a spool, the monofilament fiber comprising a polyaxial polymer of a formula M(B)₂ or M(B)₃, where M is a homopolymer or a copolymer and comprises a plurality of repeating units, where at least 50 mol %, e.g., 70 mol %, of the repeating units in M are a polymerization product of at least one of trimethylene carbonate and epsilon-caprolactone; and B is a homopolymer or a copolymer and comprises a plurality of repeating units, where at least 50 mol %, e.g., 70 mol %, of the repeating units in B are a polymerization product of at least one of glycolide and lactide.

Thus, in one embodiment the present disclosure provides a kit comprising an assembly inside of a pouch, the assembly comprising a monofilament fiber wound around a spool, the monofilament fiber comprising a polyaxial polymer of a formula M(B)₂ or M(B)₃, where M comprises a plurality of repeating units, where at least 50 mol % of the repeating units in M are a polymerization product of at least one of trimethylene carbonate and epsilon-caprolactone; and B comprises a plurality of repeating units, where at least 50 mol % of the repeating units in B are a polymerization product of at least one of glycolide and lactide. The present disclosure also provides an assembly comprising a monofilament fiber wound around a spool, the monofilament fiber comprising a polyaxial polymer of a formula M(B)₂ or M(B)₃, where M comprises a plurality of repeating units from first monomer polymerization, where at least 50 mol % of the repeating units in M are a polymerization product of at least one of trimethylene carbonate and epsilon-caprolactone, where B comprises a plurality of repeating units from second monomer polymerization, where at least 50 mol % of the repeating units in B are a polymerization product of at least one of glycolide and lactide. The present disclosure also provides a monofilament fiber comprising a polyaxial polymer of a formula M(B)₂ or M(B)₃, where M comprises a plurality of repeating units from first monomer polymerization, where at least 50 mol % of the repeating units in M are a polymerization product of at least one of trimethylene carbonate and epsilon-caprolactone, where B comprises a plurality of repeating units from second monomer polymerization, where at least 50 mol % of the repeating units in B are a polymerization product of at least one of glycolide and lactide, and furthermore the present disclosure provides a method of additive manufacturing, the method comprising: melting the monofilament to provide a molten form of the fiber; depositing the molten form to provide an initial article; and cooling the initial article to room temperature to form a solid 3-dimensional article, as well as a 3-dimensional article prepared by the method.

The following are, succinctly stated, some additional exemplary embodiments of the present disclosure:
1) A monofilament comprising a linear polymer of the formula M(B)₂ wherein M comprises a polymer having a Tg of less than 25° C. which contributes at least 5 wt % of the total weight of the M(B)₂ polymer.
2) The monofilament of embodiment 1 wherein B comprises a polymer having repeating units, where at least 20 mol % of the repeating units are low- or non-crystallizable.
3) A monofilament comprising a linear polymer of the formula M(B)₂ wherein B comprises a polymer having a Tg of less than 25° C. which contributes at least 5 wt % of the total weight of the M(B)₂ polymer.
4) The monofilament of embodiment 3 wherein M comprises a polymer having repeating units, where at least 20 mol % of the repeating units are low- or non-crystallizable.
5) A monofilament comprising a triaxial polymer of the formula M(B)₃ wherein M comprises a polymer having a Tg of less than 25° C. which contributes at least 5 wt % of the total weight of the M(B)₃ polymer.
6) The monofilament of embodiment 5 wherein B comprises a polymer having repeating units, where at least 20 mol % of the repeating units are low- or non-crystallizable.
7) A monofilament comprising a triaxial polymer of the formula M(B)₃ wherein B comprises a polymer having a Tg of less than 25° C. which contributes at least 5 wt % of the total weight of the M(B)₃ polymer.
8) The monofilament of embodiment 7 wherein M comprises a polymer having repeating units, where at least 20 mol % of the repeating units are low- or non-crystallizable.
9) A monofilament comprising a linear polymer of the formula M(B)₂ wherein B comprises a polymer having repeating units, where at least 20 mol % of the repeating units are low- or non-crystallizable.
10) The monofilament of embodiment 9 wherein M comprises a polymer having a Tg of less than 25° C. which contributes at least 5 wt % of the total weight of the M(B)₂ polymer.
11) A monofilament comprising a linear polymer of the formula M(B)₂ wherein M comprises a polymer having repeating units, where at least 20 mol % of the repeating units are low- or non-crystallizable.
12) The monofilament of embodiment 11 wherein B comprises a polymer having a Tg of less than 25° C. which contributes at least 5 wt % of the total weight of the M(B)₂ polymer.
13) A monofilament comprising a triaxial polymer of the formula M(B)₃ wherein B comprises a polymer having repeating units, where at least 20 mol % of the repeating units are low- or non-crystallizable.
14) The monofilament of embodiment 13 wherein M comprises a polymer having a Tg of less than 25° C. which contributes at least 5 wt % of the total weight of the M(B)₃ polymer.
15) A monofilament comprising a triaxial polymer of the formula M(B)₃ wherein M comprises a polymer having repeating units, where at least 20 mol % of the repeating units are low- or non-crystallizable.
16) The monofilament of embodiment 15 wherein B comprises a polymer having a Tg of less than 25° C. which contributes at least 5 wt % of the total weight of the M(B)₃ polymer.
17) The monofilament of any of embodiments 1-16 wherein M comprises a polymer selected from the group consisting of poly(trimethylene carbonate), poly(lactide) and poly(trimethylene carbonate-co-lactide).
18) The monofilament of any of embodiments 1-16 wherein M comprises a polyether, e.g., poly(ethylene oxide) or a polyester, e.g., polyethylene succinate or polypropylene succinate.
19) The monofilament of any of embodiments 1-16 wherein the at least 20 mol % of low- or non-crystallizable repeating units are residues from the polymerization of monomers selected from CAP and TMC.
20) The monofilament of embodiment 19 wherein the at least 20 mol % is less than 100 mol %.
21) The monofilament of embodiment 19 wherein the at least 20 mol % is less than 90 mol %, i.e., 20-90 mol %.
22) The monofilament of embodiment 19 wherein the at least 20 mol % is less than 80 mol %, i.e., 20-80 mol %.
23) The monofilament of embodiment 19 wherein the low- or non-crystallizable repeating units are residues from the polymerization of monomers selected from lactide, glycolide and polydioxanone.
24) The monofilament of any of embodiments 1-16 wherein B comprises residues selected from the polymerization of monomers selected from glycolide, lactide, TMC, CAP and dioxanone.
25) The monofilament of embodiment 24 wherein at least 50% of the residues in B are selected from the polymerization of monomers selected from TMC, CAP and dioxanone.
26) The monofilament of embodiment 24 wherein residue selected from the polymerization of glycolide and lactide contribute less than 100% of the residues in B.
27) The monofilament of any of embodiments 1-26 which is solid at ambient temperature but fluid with a MFI value of between about 2.5-30 grams per 10 minute sat an elevated temperature which is the operating temperature of an additive manufacturing process.
28) The monofilament of any of embodiments 1-26 which is undrawn with an orientation factor of less than 50%. 29) The monofilament of any of embodiments 1-26 having a diameter within the range of 1-5 mm.
30) The monofilament of any of embodiments 1-26 having a column buckling resistance of at least 1 Newton.
31) A method of additive manufacturing, the method comprising
   a. melting a monofilament according to any of embodiments 1-30 to provide a molten monofilament, and
   b. cooling the molten monofilament to room temperature to form a solid 3-dimensional article.
32) A kit comprising a monofilament according to any of embodiments 1-30, and instructions for using said monofilament in a method of additive manufacturing.
33) A kit comprising an assembly as described herein, e.g., a monofilament wound around a spool, and instructions for using said assembly in a method of additive manufacturing.

The herein-mentioned and additional features of the present invention and the manner of obtaining them will become apparent, and the invention will be best understood by reference to the following more detailed description. All references disclosed herein are hereby incorporated by reference in their entirety as if each was incorporated individually.

This Brief Summary has been provided to introduce certain concepts in a simplified form that are further described in detail below in the Detailed Description. Except where otherwise expressly stated, this Brief Summary is not intended to identify key or essential features of the claimed subject matter, nor is it intended to limit the scope of the claimed subject matter.

The details of one or more embodiments are set forth in the description below. The features illustrated or described in connection with one exemplary embodiment may be combined with the features of other embodiments. Thus, any of the various embodiments described herein can be combined to provide further embodiments. Aspects of the embodiments can be modified, if necessary to employ concepts of the various patents, applications and publications as identified herein to provide yet further embodiments. Other features, objects and advantages will be apparent from the description, the drawings, and the claims.

### BRIEF DESCRIPTION OF THE DRAWINGS

Exemplary features of the present disclosure, its nature and various advantages will be apparent from the accompanying drawings and the following detailed description of various embodiments. Non-limiting and non-exhaustive embodiments are described with reference to the accompanying drawings in which:

FIG. 1 shows the shape of a test printed article which was used to evaluate printing performance.

FIG. 2 is a graphic illustration of layer adhesion ultimate stress of 3D printed parts.

FIG. 3 is a differential scanning calorimetry (DSC) curve.

FIG. 4 is a DSC curve.

FIG. 5 is a DSC curve.

FIG. 6 is a graphic illustration of layer adhesion ultimate stress of 3D printed parts.

### DETAILED DESCRIPTION

The present disclosure may be understood more readily by reference to the following detailed description of embodiments of the disclosure and the Examples included herein.

Briefly stated, the present disclosure provides methods for additive printing, polymeric compositions for use therein, and products made thereby. Thus, the present disclosure provides compositions useful in additive manufacturing, methods of conducting additive manufacturing that make use of the compositions of the present disclosure, and products made by the additive manufacturing process, and related subjects.

In one aspect, the present disclosure provides monofilaments that area useful in in additive manufacturing. As discussed in detail herein, those monofilaments may, in part, be described by their properties, which include melting point, melt flow index and intrinsic viscosity.

### Monofilament Compositions

The present disclosure provides monofilaments, and particularly monofilaments formed from either diaxial (abbreviated by the formula M(B)₂) or triaxial (abbreviated by the formula M(B)₃) copolymers, where each of M and B are distinct polymer blocks having non-identical compositions as described herein.

The following are, succinctly stated, some of the exemplary monofilaments of the present disclosure:
1) A monofilament comprising a linear polymer of the formula M(B)₂ wherein M comprises a polymer having a Tg of less than 25° C. which contributes at least 5 wt % of the total weight of the M(B)₂ polymer. Optionally, the Tg is less than any of: 24° C., or 23° C., or 22° C., or 21° C., or 20° C., or 19° C., or 18° C., or 17° C., or 16° C., or 15° C., or 14° C., or 13° C., or 12° C., or 11° C., or 10° C., or 9° C., or 8° C., or 7° C., or 6° C., or 5° C., or 4° C., or 3° C., or 2° C., or 1° C., or 0° C. Independently, the polymer may be described by M contributing at least any of: 6 wt %, or 7 wt %, or 8 wt %, or 9 wt %, or 10 wt %, or 11 wt %, or 12 wt %, or 13 wt %, or 14 wt %, or 15 wt %, or 16 wt %, or 17 wt %, or 18 wt %, or 19 wt %, or 20 wt %, or 21 wt %, or 22 wt %, or 23 wt %, or 24 wt %, or 25 wt %, or 26 wt %, or 27 wt %, or 28 wt %, or 29 wt %, or 30 wt %, or 31 wt %, or 32 wt %, or 33 wt %, or 34 wt %, or 35 wt %, or 36 wt %, or 37 wt %, or 38 wt %, or 39 wt %, or 40 wt % of the total weight of the M(B)₂ polymer.
2) The monofilament of embodiment 1 wherein B comprises a polymer having repeating units, where at least 20 mol % of the repeating units are low- or non-crystallizable. Optionally, at least any of: 25 mol %, or 30 mol %, or 35 mol %, or 40 mol %, or 45 mol %, or 50 mol %, or 55 mol %, or 60 mol %, or 65 mol %, or 70 mol %, or 75 mol %, or 80 mol % of the repeating units are low- or non-crystallizable, however, it may optionally be specified that not all of, i.e., less than 100 mol % of, the repeating units are low- or non-crystallizable, e.g., less than any of: 98 mol %, or 96 mol %, or 94 mol %, or 92 mol %, or 90 mol %, or 88 mol %, or 86 mol %, or 84 mol %, or 82 mol %, or 80 mol % are low- or non-crystallizable.
3) A monofilament comprising a linear polymer of the formula M(B)₂ wherein B comprises a polymer having a Tg of less than 25° C. which contributes at least 5 wt % of the total weight of the M(B)₂ polymer. Optionally, the Tg is less than any of: 24° C., or 23° C., or 22° C., or 21° C., or 20° C., or 19° C., or 18° C., or 17° C., or 16° C., or 15° C., or 14° C., or 13° C., or 12° C., or 11° C., or 10° C., or 9° C., or 8° C., or 7° C., or 6° C., or 5° C., or 4° C., or 3° C., or 2° C., or 1° C., or 0° C. Independently, the polymer may be described by M contributing at least any of: 6 wt %, or 7 wt %, or 8 wt %, or 9 wt %, or 10 wt %, or 11 wt %, or 12 wt %, or 13 wt %, or 14 wt %, or 15 wt %, or 16 wt %, or 17 wt %, or 18 wt %, or 19 wt %, or 20 wt %, or 21 wt %, or 22 wt %, or 23 wt %, or 24 wt %, or 25 wt %, or 26 wt %, or 27 wt %, or 28 wt %, or 29 wt %, or 30 wt %, or 31 wt %, or 32 wt %, or 33 wt %, or 34 wt %, or 35 wt %, or 36 wt %, or 37 wt %, or 38 wt %, or 39 wt %, or 40 wt % of the total weight of the M(B)₂ polymer.
4) The monofilament of embodiment 3 wherein M comprises a polymer having repeating units, where at least 20 mol % of the repeating units are low- or non-crystallizable. Optionally, at least any of: 25 mol %, or 30 mol %, or 35 mol %, or 40 mol %, or 45 mol %, or 50 mol %, or 55 mol %, or 60 mol %, or 65 mol %, or 70 mol %, or 75 mol %, or 80 mol % of the repeating units are low- or non-crystallizable, however, it may optionally be specified that not all of, i.e., less than 100 mol % of, the repeating units are low- or non-crystallizable, e.g., less than any of: 98 mol %, or 96 mol %, or 94 mol %, or 92 mol %, or 90 mol %, or 88 mol %, or 86 mol %, or 84 mol %, or 82 mol %, or 80 mol % are low- or non-crystallizable.
5) A monofilament comprising a triaxial polymer of the formula M(B)₃ wherein M comprises a polymer having a Tg of less than 25° C. which contributes at least 5 wt % of the total weight of the M(B)₃ polymer. Optionally, the Tg is less than any of: 24° C., or 23° C., or 22° C., or 21° C., or 20° C., or 19° C., or 18° C., or 17° C., or 16° C., or 15° C., or 14° C., or 13° C., or 12° C., or 11° C., or 10° C., or 9° C., or 8° C., or 7° C., or 6° C., or 5° C., or 4° C., or 3° C., or 2° C., or 1° C., or 0° C. Independently, the polymer may be described by M contributing at least any of: 6 wt %, or 7 wt %, or 8 wt %, or 9 wt %, or 10 wt %, or 11 wt %, or 12 wt %, or 13 wt %, or 14 wt %, or 15 wt %, or 16 wt %, or 17 wt %, or 18 wt %, or 19 wt %, or 20 wt %, or 21 wt %, or 22 wt %, or 23 wt %, or 24 wt %, or 25 wt %, or 26 wt %, or 27 wt %, or 28 wt %, or 29 wt %, or 30 wt %, or 31 wt %, or 32 wt %, or 33 wt %, or 34 wt %, or 35 wt %, or 36 wt %, or 37 wt %, or 38 wt %, or 39 wt %, or 40 wt % of the total weight of the M(B)₃ polymer,
6) The monofilament of embodiment 5 wherein B comprises a polymer having repeating units, where at least 20 mol % of the repeating units are low- or non-crystallizable. Optionally, at least any of: 25 mol %, or 30 mol %, or 35 mol %, or 40 mol %, or 45 mol %, or 50 mol %, or 55 mol %, or 60 mol %, or 65 mol %, or 70 mol %, or 75 mol %, or 80 mol % of the repeating units are low- or non-crystallizable, however, it may optionally be specified that not all of, i.e., less than 100 mol % of, the repeating units are low- or non-crystallizable, e.g., less than any of: 98 mol %, or 96 mol %, or 94 mol %, or 92 mol %, or 90 mol %, or 88 mol %, or 86 mol %, or 84 mol %, or 82 mol %, or 80 mol % are low- or non-crystallizable.
7) A monofilament comprising a triaxial polymer of the formula M(B)₃ wherein B comprises a polymer having a Tg of less than 25° C. which contributes at least 5 wt % of the total weight of the M(B)₃ polymer. Optionally, the Tg is less than any of: 24° C., or 23° C., or 22° C., or 21° C., or 20° C., or 19° C., or 18° C., or 17° C., or 16° C., or 15° C., or 14° C., or 13° C., or 12° C., or 11° C., or 10° C., or 9° C., or 8° C., or 7° C., or 6° C., or 5° C., or 4° C., or 3° C., or 2° C., or 1° C., or 0° C. Independently, the polymer may be described by M contributing at least any of: 6 wt %, or 7 wt %, or 8 wt %, or 9 wt %, or 10 wt %, or 11 wt %, or 12 wt %, or 13 wt %, or 14 wt %, or 15 wt %, or 16 wt %, or 17 wt %, or 18 wt %, or 19 wt %, or 20 wt %, or 21 wt %, or 22 wt %, or 23 wt %, or 24 wt %, or 25 wt %, or 26 wt %, or 27 wt %, or 28 wt %, or 29 wt %, or 30 wt %, or 31 wt %, or 32 wt %, or 33 wt %, or 34 wt %, or 35 wt %, or 36 wt %, or 37 wt %, or 38 wt %, or 39 wt %, or 40 wt % of the total weight of the M(B)₃ polymer.
8) The monofilament of embodiment 7 wherein M comprises a polymer having repeating units, where at least 20 mol % of the repeating units are low- or non-crystallizable. Optionally, at least any of: 25 mol %, or 30 mol %, or 35 mol %, or 40 mol %, or 45 mol %, or 50 mol %, or 55 mol %, or 60 mol %, or 65 mol %, or 70 mol %, or 75 mol %, or 80 mol % of the repeating units are low- or non-crystallizable, however, it may optionally be specified that not all of, i.e., less than 100 mol % of, the repeating units are low- or non-crystallizable, e.g., less than any of: 98 mol %, or 96 mol %, or 94 mol %, or 92 mol %, or 90 mol %, or 88 mol %, or 86 mol %, or 84 mol %, or 82 mol %, or 80 mol % are low- or non-crystallizable.
9) A monofilament comprising a linear polymer of the formula M(B)₂ wherein B comprises a polymer having repeating units, where at least 20 mol % of the repeating units are low- or non-crystallizable. Optionally, at least any of: 25 mol %, or 30 mol %, or 35 mol %, or 40 mol %, or 45 mol %, or 50 mol %, or 55 mol %, or 60 mol %, or 65 mol %, or 70 mol %, or 75 mol %, or 80 mol % of the repeating units are low- or non-crystallizable, however, it may optionally be specified that not all of, i.e., less than 100 mol % of, the repeating units are low- or non-crystallizable, e.g., less than any of: 98 mol %, or 96 mol %, or 94 mol %, or 92 mol %, or 90 mol %, or 88 mol %, or 86 mol %, or 84 mol %, or 82 mol %, or 80 mol % are low- or non-crystallizable.
10) The monofilament of embodiment 9 wherein M comprises a polymer having a Tg of less than 25° C. which contributes at least 5 wt % of the total weight of the M(B)₂ polymer. Optionally, the Tg is less than any of: 24° C., or 23° C., or 22° C., or 21° C., or 20° C., or 19° C., or 18° C., or 17° C., or 16° C., or 15° C., or 14° C., or 13° C., or 12° C., or 11° C., or 10° C., or 9° C., or 8° C., or 7° C., or 6° C., or 5° C., or 4° C., or 3° C., or 2° C., or 1° C., or 0° C. Independently, the polymer may be described by M contributing at least any of: 6 wt %, or 7 wt %, or 8 wt %, or 9 wt %, or 10 wt %, or 11 wt %, or 12 wt %, or 13 wt %, or 14 wt %, or 15 wt %, or 16 wt %, or 17 wt %, or 18 wt %, or 19 wt %, or 20 wt %, or 21 wt %, or 22 wt %, or 23 wt %, or 24 wt %, or 25 wt %, or 26 wt %, or 27 wt %, or 28 wt %, or 29 wt %, or 30 wt %, or 31 wt %, or 32 wt %, or 33 wt %, or 34 wt %, or 35 wt %, or 36 wt %, or 37 wt %, or 38 wt %, or 39 wt %, or 40 wt % of the total weight of the M(B)₂ polymer.
11) A monofilament comprising a linear polymer of the formula M(B)₂ wherein M comprises a polymer having repeating units, where at least 20 mol % of the repeating units are low- or non-crystallizable. Optionally, at least any of: 25 mol %, or 30 mol %, or 35 mol %, or 40 mol %, or 45 mol %, or 50 mol %, or 55 mol %, or 60 mol %, or 65 mol %, or 70 mol %, or 75 mol %, or 80 mol % of the repeating units are low- or non-crystallizable, however, it may optionally be specified that not all of, i.e., less than 100 mol % of, the repeating units are low- or non-crystallizable, e.g., less than any of: 98 mol %, or 96 mol %, or 94 mol %, or 92 mol %, or 90 mol %, or 88 mol %, or 86 mol %, or 84 mol %, or 82 mol %, or 80 mol % are low- or non-crystallizable.
12) The monofilament of embodiment 11 wherein B comprises a polymer having a Tg of less than 25° C. which contributes at least 5 wt % of the total weight of the M(B)₂ polymer. Optionally, the Tg is less than any of: 24° C., or 23° C., or 22° C., or 21° C., or 20° C., or 19° C., or 18° C., or 17° C., or 16° C., or 15° C., or 14° C., or 13° C., or 12° C., or 11° C., or 10° C., or 9° C., or 8° C., or 7° C., or 6° C., or 5° C., or 4° C., or 3° C., or 2° C., or 1° C., or 0° C. Independently, the polymer may be described by M contributing at least any of: 6 wt %, or 7 wt %, or 8 wt %, or 9 wt %, or 10 wt %, or 11 wt %, or 12 wt %, or 13 wt %, or 14 wt %, or 15 wt %, or 16 wt %, or 17 wt %, or 18 wt %, or 19 wt %, or 20 wt %, or 21 wt %, or 22 wt %, or 23 wt %, or 24 wt %, or 25 wt %, or 26 wt %, or 27 wt %, or 28 wt %, or 29 wt %, or 30 wt %, or 31 wt %, or 32 wt %, or 33 wt %, or 34 wt %, or 35 wt %, or 36 wt %, or 37 wt %, or 38 wt %, or 39 wt %, or 40 wt % of the total weight of the M(B)₂ polymer.
13) A monofilament comprising a triaxial polymer of the formula M(B)₃ wherein B comprises a polymer having repeating units, where at least 20 mol % of the repeating units are low- or non-crystallizable. Optionally, at least any of: 25 mol %, or 30 mol %, or 35 mol %, or 40 mol %, or 45 mol %, or 50 mol %, or 55 mol %, or 60 mol %, or 65 mol %, or 70 mol %, or 75 mol %, or 80 mol % of the repeating units are low- or non-crystallizable, however, it may optionally be specified that not all of, i.e., less than 100 mol % of, the repeating units are low- or non-crystallizable, e.g., less than any of: 98 mol %, or 96 mol %, or 94 mol %, or 92 mol %, or 90 mol %, or 88 mol %, or 86 mol %, or 84 mol %, or 82 mol %, or 80 mol % are low- or non-crystallizable.
14) The monofilament of embodiment 13 wherein M comprises a polymer having a Tg of less than 25° C. which contributes at least 5 wt % of the total weight of the M(B)₃ polymer. Optionally, the Tg is less than any of: 24° C., or 23° C., or 22° C., or 21° C., or 20° C., or 19° C., or 18° C., or 17° C., or 16° C., or 15° C., or 14° C., or 13° C., or 12° C., or 11° C., or 10° C., or 9° C., or 8° C., or 7° C., or 6° C., or 5° C., or 4° C., or 3° C., or 2° C., or 1° C., or 0° C. Independently, the polymer may be described by M contributing at least any of: 6 wt %, or 7 wt %, or 8 wt %, or 9 wt %, or 10 wt %, or 11 wt %, or 12 wt %, or 13 wt %, or 14 wt %, or 15 wt %, or 16 wt %, or 17 wt %, or 18 wt %, or 19 wt %, or 20 wt %, or 21 wt %, or 22 wt %, or 23 wt %, or 24 wt %, or 25 wt %, or 26 wt %, or 27 wt %, or 28 wt %, or 29 wt %, or 30 wt %, or 31 wt %, or 32 wt %, or 33 wt %, or 34 wt %, or 35 wt %, or 36 wt %, or 37 wt %, or 38 wt %, or 39 wt %, or 40 wt % of the total weight of the M(B)₃ polymer.
15) A monofilament comprising a triaxial polymer of the formula M(B)₃ wherein M comprises a polymer having repeating units, where at least 20 mol % of the repeating units are low- or non-crystallizable. Optionally, at least any of: 25 mol %, or 30 mol %, or 35 mol %, or 40 mol %, or 45 mol %, or 50 mol %, or 55 mol %, or 60 mol %, or 65 mol %, or 70 mol %, or 75 mol %, or 80 mol % of the repeating units are low- or non-crystallizable, however, it may optionally be specified that not all of, i.e., less than 100 mol % of, the repeating units are low- or non-crystallizable, e.g., less than any of: 98 mol %, or 96 mol %, or 94 mol %, or 92 mol %, or 90 mol %, or 88 mol %, or 86 mol %, or 84 mol %, or 82 mol %, or 80 mol % are low- or non-crystallizable.
16) The monofilament of embodiment 15 wherein B comprises a polymer having a Tg of less than 25° C. which contributes at least 5 wt % of the total weight of the M(B)₃ polymer. Optionally, the Tg is less than any of: 24° C., or 23° C., or 22° C., or 21° C., or 20° C., or 19° C., or 18° C., or 17° C., or 16° C., or 15° C., or 14° C., or 13° C., or 12° C., or 11° C., or 10° C., or 9° C., or 8° C., or 7° C., or 6° C., or 5° C., or 4° C., or 3° C., or 2° C., or 1° C., or 0° C. Independently, the polymer may be described by M contributing at least any of: 6 wt %, or 7 wt %, or 8 wt %, or 9 wt %, or 10 wt %, or 11 wt %, or 12 wt %, or 13 wt %, or 14 wt %, or 15 wt %, or 16 wt %, or 17 wt %, or 18 wt %, or 19 wt %, or 20 wt %, or 21 wt %, or 22 wt %, or 23 wt %, or 24 wt %, or 25 wt %, or 26 wt %, or 27 wt %, or 28 wt %, or 29 wt %, or 30 wt %, or 31 wt %, or 32 wt %, or 33 wt %, or 34 wt %, or 35 wt %, or 36 wt %, or 37 wt %, or 38 wt %, or 39 wt %, or 40 wt % of the total weight of the M(B)₃ polymer
17) The monofilament of any of embodiments 1-16 wherein M comprises a polymer selected from the group consisting of poly(trimethylene carbonate), poly(lactide) and poly(trimethylene carbonate-co-lactide).
18) The monofilament of any of embodiments 1-16 wherein M comprises a polyether, e.g., poly(ethylene oxide) or a polyester, e.g., polyethylene succinate or polypropylene succinate.
19) The monofilament of any of embodiments 1-16 wherein the at least 20 mol % of low- or non-crystallizable repeating units are residues from the polymerization of monomers selected from CAP and TMC.
20) The monofilament of embodiment 19 wherein the at least 20 mol % is less than 100 mol %.
21) The monofilament of embodiment 19 wherein the at least 20 mol % is less than 90 mol %, i.e., 20-90 mol %.
22) The monofilament of embodiment 19 wherein the at least 20 mol % is less than 80 mol %, i.e., 20-80 mol %.
23) The monofilament of embodiment 19 wherein the low- or non-crystallizable repeating units are residues from the polymerization of monomers selected from lactide, glycolide and polydioxanone.
24) The monofilament of any of embodiments 1-16 wherein B comprises residues selected from the polymerization of monomers selected from glycolide, lactide, TMC, CAP and dioxanone.
25) The monofilament of embodiment 24 wherein at least 50% of the residues in B are selected from the polymerization of monomers selected from TMC, CAP and dioxanone.
26) The monofilament of embodiment 24 wherein residue selected from the polymerization of glycolide and lactide contribute less than 100% of the residues in B.
27) The monofilament of any of embodiments 1-26 which is solid at ambient temperature but fluid with a MFI value of between about 2.5-30 grams per 10 minute sat an elevated temperature which is the operating temperature of an additive manufacturing process.
28) The monofilament of any of embodiments 1-26 which is undrawn with an orientation factor of less than 50%.
29) The monofilament of any of embodiments 1-26 having a diameter within the range of 1-5 mm.
30) The monofilament of any of embodiments 1-26 having a column buckling resistance of at least 1 Newton.

The monofilament may comprise copolymers as described below. A copolymer refers to a polymer made from two or more different repeating units.

In order to form the M block, monomers may be reacted with an initiator. In one embodiment, the initiator is difunctional, such that the monomer forms repeating units extending from two sites on the initiator to form the M portion of the M(B)₂ copolymer. Exemplary difunctional initiators include diols and diamines, e.g., ethylene glycol and ethylene diamine. In another embodiment, the initiator is trifunctional, such that the monomer forms repeating units from three sites on the initiator to form the M portion of the M(B)₃ copolymer. Exemplary trifunctional initiators include triols and triamines, e.g., glycerol. In one embodiment, the initiator is tetrafunctional, such that monomer forms repeating units extending from four sites on the initiator. Exemplary tetrafunctional initiators include tetra-ols and tetra-amines, e.g., pentaerythritol. A tetrafunctional initiator may be used to form a tetrafunctional M group in M(B)₄ copolymers.

The polymeric chains that extend from the initiator may be segmented, in other words, each polymeric chain that extends directly from the initiator may itself provide an initiation site for the extension of a second polymeric chain. This situation can be represented by (I₂)(A-A′)₂, where I₂-A may also be denoted herein as M, where the initiator (I₂) has two initiation sites, polymeric segment A extends directly from I (to form M), and polymeric segment A′ extends directly from the end of polymeric segment A to create A-A′ polymeric chains, where two of such chains extend from a difunctional initiator. A similar situation can also be represented by (I₃)(A-B)₃, where I₃-A may also be denoted herein as M, where the initiator (I₃) has three initiation sites, polymeric segment A extends directly from I (to form M), and polymeric segment A′ extends directly from the end of polymeric segment A to create A-A′ polymeric chains, where three of such chains extend from the initiator.

When the initiator is difunctional, the resulting copolymer may be described as linear or diaxial, when the initiator is trifunctional the resulting copolymer may be described as triaxial, and when the initiator is tetrafunctional the resulting copolymer may be described as tetraaxial. Such copolymers may be referred to collectively as segmented copolymers, where the polymeric chain A is referred to as the central block or central segment, and the polymeric chain A′ is referred to as the end block or end segment or end graft. Any one or more of the diaxial and triaxial and tetraaxial polymers may be referred to herein as polyaxial polymers.

### Lactide (LAC)-Containing Copolymer

In one aspect, the copolymer contains repeating units from the monomer lactic acid or lactide (collectively, LAC) and one or more additional monomer. The one or more additional monomer may be selected from glycolic acid or glycolide (GLY), ε-caprolactone (CAP) and trimethylene carbonate (TMC).

For example, the copolymer may contain repeating units from LAC and GLY, and optionally no other monomer. In another embodiment, the copolymer may contain repeating units from LAC and TMC, and optionally no other monomer. As a further embodiment, the copolymer may contain repeating units from LAC and CAP, and optionally no other monomer.

As another example, in one embodiment the copolymer is a linear copolymer that contains repeating units from LAC, TMC and CAP. In one embodiment, the linear copolymer contains 70-80 weight percent LAC, 10-20 weight percent TMC and 10-20 weight percent CAP, each weight percent based on the total weight of LAC, TMC and CAP in the copolymer, e.g., 70-75% LAC, 10-15% TMC and 10-15% CAP. In another example, the copolymer is a triaxial copolymer that contains repeating units from LAC, TMC and CAP. In one embodiment, the triaxial copolymer contains 70-80 weight percent LAC, 10-20 weight percent TMC and 10-20 weight percent CAP, each weight percent based on the total weight of LAC, TMC and CAP in the copolymer, e.g., 70-75 wt % LAC, 10-15 wt % TMC and 10-15 wt % CAP.

As another example, in one embodiment the copolymer is a linear copolymer compositionally described by 30-50/20-40/20-30/1-10 of LAC/CAP/TMC/GLY, e.g., 40/30/26/4 of LAC/CAP/TMC/GLY.

### Glycolide (Gly)-Containing Copolymer

In one aspect, the copolymer contains repeating units from the monomer glycolic acid or glycolide and one or more additional monomer. The one or more additional monomer may be selected from lactic acid or lactide (LAC), ε-caprolactone (CAP) and trimethylene carbonate (TMC).

For example, the copolymer may contain repeating units from GLY and LAC, and optionally no other monomer. As another example, the copolymer may contain repeating units from GLY and TMC, and optionally no other monomer.

As another example, the copolymer may contain repeating units from GLY and CAP, and optionally no other monomer. For instance, the copolymer may be a linear copolymer and may contain 70-99 wt % GLY and 30-01 wt % CAP, as the only monomers, where exemplary copolymers have 90-97 wt % GLY and 10-03 wt % CAP, or have 70-80 wt % GLY and 30-20 wt % CAP. In another embodiment, the copolymer may be a triaxial copolymer and may contain 70-99 wt % GLY and 30-01 wt % CAP, as the only monomers, where exemplary copolymers have 90-97 wt % GLY and 10-03 wt % CAP, or have 70-80 wt % GLY and 30-20 wt % CAP. In one embodiment the initiator is polyethylene succinate while in another embodiment the initiator is trimethylenecarbonate.

As another example, the copolymer is a linear copolymer that contains repeating units from GLY, TMC and CAP. In one embodiment, the linear copolymer contains 50-60 weight percent GLY, 20-30 weight percent TMC and 15-25 weight percent CAP, each weight percent based on the total weight of GLY, TMC and CAP in the copolymer, e.g., 50-55% GLY, 20-25% TMC and 20-25% CAP. In another example, the copolymer is a triaxial copolymer that contains repeating units from GLY, TMC and CAP. In one embodiment, the triaxial copolymer contains 50-60 weight percent GLY, 20-30 weight percent TMC and 15-25 weight percent CAP, each weight percent based on the total weight of GLY, TMC and CAP in the copolymer, e.g., 50-55% GLY, 20-25% TMC and 20-25% CAP.

### Epsilon-Caprolactone (CAP)-Containing Copolymer

In one aspect, the copolymer contains repeating units from the monomer ε-caprolactone and one or more additional monomer. The one or more additional monomer may be selected from lactic acid/lactide (LAC), glycolic acid/glycolide (GLY), and trimethylene carbonate (TMC).

### Trimethylene Carbonate (TMC)-Containing Copolymer

In one aspect, the copolymer contains repeating units from the monomer trimethylene carbonate (TMC) and one or more additional monomer. The one or more additional monomer may be selected from lactic acid/lactide (LAC), glycolic acid/glycolide (GLY), and ε-caprolactone (CAP).

### Dioxanone-Containing Copolymer

In one aspect, the copolymer contains repeating units from the monomer dioxanone.

### Lactones

In one aspect, the copolymer contains repeating units from the monomer delta-valerolactone. In one aspect, the copolymer contains repeating units from the monomer epsilon-decalactone. In one aspect, the copolymer contains repeating units selected from the monomers delta-valerolactone and epsilon-decalactone.

### Linear Copolymer

In one embodiment, the polymer is a linear polymer, which refers to a polymer that does not have branching from its backbone. As explained herein, a linear polymer may be described by the designation M(B)₂ or (I₂)(A-A′)₂, where A and A′ refer to different polymers (including copolymers), e.g., polyesters. When the polymer has the (I₂)(A-A′)₂ structure, A may be referred to as the central block and A′ may be referred to as the end graft, and collectively A-A′ are the arms of the linear polymer. However, the linear polymer may alternatively be described by the designation (I₂)(A)₂, where A refers to a polyester.

In describing the composition of the arms of a linear copolymer, a convenient designation for the arms is the residue description: wt %1/wt %2 mononer1/monomer2. For example, a linear polymer described by the residue description 65/35 GLY/TMC indicates that each of the two arms is a copolymer formed by 65 wt % GLY and 35 wt % TMC residues, where the weight percent values are based on the total weight of the GLY and TMC in the polymer. By analogy, the residue description 93/5/2 GLY/CAP/TMC indicates that each of the two arms is a copolymer formed by 93 wt % GLY, 5 wt % CAP and 2 wt % TMC residues, where the weight percent values are based on the total weight of the GLY, CAP and TMC in the polymer.

When the linear polymer has both a central block and an end graft, such polymers may be designated by: central block wt % residue description; end graft residue description. In this case, the wt % value indicates the percent of total residue weight that is present in the central block, based on the total weight of residues present in the polymer. For example, a linear polymer identified by central block 10% 85/15 CAP/LAC; end graft 94/9 LAC/GLY indicates that 10% of the total residue weight is present in the central block and thus 90% of the total residue weight is present in the end grafts. The central block contains 85 wt % CAP residues and 15 wt % LAC residues, based on the total weight of the residues present in the central block of the polymer. The end grafts contain 94 wt % LAC residues and 6 wt % GLY residues based on the total weight of the residues present in the arms of the polymer.

The following are additional exemplary linear polymers which may create a monofilament of the present disclosure.

In one embodiment, the linear polymer may be described by:
70-80/10-20/5-15 LAC/TMC/CAP; or
71-79/11-19/6-14 LAC/TMC/CAP; or
72-78/12-18/7-13 LAC/TMC/CAP; or
72-76/13-17/9-13 LAC/TMC/CAP.

In one embodiment, the linear polymer may be described by:
central block 5-15% TMC; end graft 90-99/1-10 LAC/CAP; or
central block 5-7% TMC; end graft 90-99/1-10 LAC/CAP; or
central block 6-8% TMC; end graft 90-99/1-10 LAC/CAP; or
central block 7-9% TMC; end graft 90-99/1-10 LAC/CAP; or
central block 8-10% TMC; end graft 90-99/1-10 LAC/CAP; or
central block 9-11% TMC; end graft 90-99/1-10 LAC/CAP; or
central block 10-12% TMC; end graft 90-99/1-10 LAC/CAP; or
central block 11-13% TMC; end graft 80-90/10-20 CAP/LAC; or
central block 12-14% TMC; end graft 80-90/10-20 CAP/LAC; or
central block 13-15% TMC; end graft 80-90/10-20 CAP/LAC;
where, in each of the above, end graft 90-99/1-10 LAC/CAP may optionally be replaced with end graft 90-95/5-10 LAC/CAP.

In one embodiment, the linear polymer may be described by:
central block 5-15% PEG; end graft 85-95/5-15 LAC/GLY; or
central block 5-7% PEG; end graft 85-95/5-15 LAC/GLY; or
central block 6-8% PEG; end graft 85-95/5-15 LAC/GLY; or
central block 7-9% PEG; end graft 85-95/5-15 LAC/GLY; or
central block 8-10% PEG; end graft 85-95/5-15 LAC/GLY; or
central block 9-11% PEG; end graft 85-95/5-15 LAC/GLY; or
central block 10-12% PEG; end graft 85-95/5-15 LAC/GLY; or
central block 11-13% PEG; end graft 85-95/5-15 LAC/GLY; or
central block 12-14% PEG; end graft 85-95/5-15 LAC/GLY; or
central block 13-15% PEG; end graft 85-95/5-15 LAC/GLY;
where, in each of the above, PEG refers to a polyethylene glycol, and independently, 85-95/5-15 LAC/GLY; may optionally be replaced with 88-92/8-12 LAC/GLY.

In one embodiment, the linear polymer may be described by:
central block 1-10% PEG; graft 11-5% TMC; end graft 90-99% PDO; or
central block 1-3% PEG; graft 1 1-5% TMC; end graft 90-99% PDO; or
central block 2-4% PEG; graft 1 1-5% TMC; end graft 90-99% PDO; or
central block 3-5% PEG; graft 1 1-5% TMC; end graft 90-99% PDO; or
central block 4-6% PEG; graft 11-5% TMC; end graft 90-99% PDO; or
central block 5-7% PEG; graft 11-5% TMC; end graft 90-99% PDO; or
central block 6-8% PEG; graft 1 1-5% TMC; end graft 90-99% PDO; or
central block 7-9% PEG; graft 11-5% TMC; end graft 90-99% PDO; or
central block 8-10% PEG; graft 11-5% TMC; end graft 90-99% PDO;
where, in each of the above, PEG refers to a polyethylene glycol and independently, graft 1 1-5% TMC refers to graft 11% TMC; and independently end graft 90-99% PDO refers to end graft 92-94% PDO.

In one embodiment, the linear polymer may be described by:
central block 1-10% PEG; end graft 85-95/5-15 GLY/TMC; or
central block 1-3% PEG; end graft 85-95/5-15 GLY/TMC; or
central block 2-4% PEG; end graft 85-95/5-15 GLY/TMC; or
central block 3-5% PEG; end graft 85-95/5-15 GLY/TMC; or
central block 4-6% PEG; end graft 85-95/5-15 GLY/TMC; or
central block 5-7% PEG; end graft 85-95/5-15 GLY/TMC; or
central block 6-8% PEG; end graft 85-95/5-15 GLY/TMC; or
central block 7-9% PEG; end graft 85-95/5-15 GLY/TMC; or
central block 8-10% PEG; end graft 85-95/5-15 GLY/TMC;
where, in each of the above, PEG refers to a polyethylene glycol and independently, end graft 85-95/5-15 GLY/TMC refers to 88-92/8-12 GLY/TMC.

In one embodiment, the linear polymer may be described by:
85-95/5-15 LAC/TMC; or
86-94/6-14 LAC/TMC; or
87-93/7-13 LAC/TMC; or
88-92/8-12 LAC/TMC; or
89-91/9-11 LAC/TMC.

In one embodiment, the linear polymer may be described by:
60-70/20-30/1-10 GLY/PPG/PEG; or
61-69/22-30/2-8 GLY/PPG/PEG; or
62-68/24-30/3-7 GLY/PPG/PEG;
wherein, independently at each occurrence, PPG refers to polypropylene glycol, and PEG refers to polyethylene glycol.

In one embodiment, the linear polymer may be described by:
70-90/10-30 PDO/PEG; or
72-88/12-28 PDO/PEG; or
74-86/14-26 PDO/PEG; or
76-84/16-24 PDO/PEG; or
78-82/18-22 PDO/PEG;
wherein PEG refers to polyethylene glycol.

In one embodiment, the linear polymer may be described by:
65-75/15-25/5-15/1-10 LAC/PEG/TMC/CAP; or
66-74/16-24/6-14/1-8 LAC/PEG/TMC/CAP; or
67-73/17-23/7-13/1-6 LAC/PEG/TMC/CAP; or
68-72/18-22/8-12/1-4 LAC/PEG/TMC/CAP;
wherein PEG refers to polyethylene glycol.

In one embodiment, the linear polymer may be described by:
85-95/5-15/1-10 LAC/GLY/PEG; or
86-94/6-14/2-9 LAC/GLY/PEG; or
87-93/7-13/3-8 LAC/GLY/PEG; or
85-91/5-10/2-6 LAC/GLY/PEG;
wherein PEG refers to polyethylene glycol.

### Triaxial Copolymer

In one embodiment, the polymer is a triaxial polymer, which refers to a polymer having three arms radiating from a central core, which may be denoted as M(B)₃ herein. As explained herein, a triaxial polymer may be described by the designation (I₃)(A-A′)₃, where A and A′ refer to different polymers or copolymer, e.g., polyesters. When the polymer has the (I₃)(A-A′)₃ structure, A may be referred to as the central block and A′ may be referred to as the end graft. However, the triaxial polymer may alternatively be described by the designation (I₃)(A)₃, where A refers to a polymer, e.g., a polyester.

In describing the composition of the arms of a triaxial copolymer, a convenient designation for the arms is the residue description: wt %1/wt %2 mononer1/monomer2. For example, a triaxial polymer described by the residue description 65/35 GLY/TMC indicates that each of the three arms is a copolymer formed by 65 wt % GLY and 35 wt % TMC residues, where the weight percent values are based on the total weight of the GLY and TMC in the polymer. By analogy, the residue description 93/5/2 GLY/CAP/TMC indicates that each of the three arms is a copolymer formed by 93 wt % GLY, 5 wt % CAP and 2 wt % TMC residues, where the weight percent values are based on the total weight of the GLY, CAP and TMC in the polymer.

When the triaxial polymer has both a central block and an end graft, such polymers may be designated by: central block wt % residue description; end graft residue description. In this case, the wt % value indicates the percent of total residue weight that is present in the central block, based on the total weight of residues present in the polymer. For example, a triaxial polymer identified by central block 10% 85/15 CAP/LAC; end graft 94/9 LAC/GLY indicates that 10% of the total residue weight is present in the central block and thus 90% of the total residue weight is present in the end grafts. The central block contains 85 wt % CAP residues and 15 wt % LAC residues, based on the total weight of the residues present in the central block of the polymer. The end grafts contain 94 wt % LAC residues and 6 wt % GLY residues based on the total weight of the residues present in the arms of the polymer.

The following are additional exemplary triaxial polymers that may be used to form monofilaments as described herein.

In one embodiment, the triaxial polymer may be described by:
50-60/20-30/15-25 GLY/TMC/CAP; or
51-59/21-29/16-24 GLY/TMC/CAP; or
52-58/22-28/17-23 GLY/TMC/CAP; or
53-57/23-27/18-22 GLY/TMC/CAP.

In one embodiment, the triaxial polymer may be described by
central block 1-10% polyethylene succinate; end graft 70-80/20-30 GLY/CAP; or
central block 1-3% polyethylene succinate; end graft 70-80/20-30 GLY/CAP; or
central block 2-4% polyethylene succinate; end graft 70-80/20-30 GLY/CAP; or
central block 3-5% polyethylene succinate; end graft 70-80/20-30 GLY/CAP; or
central block 4-6% polyethylene succinate; end graft 70-80/20-30 GLY/CAP; or
central block 5-7% polyethylene succinate; end graft 70-80/20-30 GLY/CAP; or
central block 6-8% polyethylene succinate; end graft 70-80/20-30 GLY/CAP; or
central block 7-9% polyethylene succinate; end graft 70-80/20-30 GLY/CAP; or
central block 8-10% polyethylene succinate; end graft 70-80/20-30 GLY/CAP;
where, in each of the above, 70-80/20-30 GLY/CAP may optionally be replaced with 74-78/22-26 GLY/CAP.

In one embodiment, the triaxial polymer may be described by
central block 1-10% TMC; end graft 90-99/1-10 GLY/CAP; or
central block 1-3% TMC; end graft 90-99/1-10 GLY/CAP; or
central block 2-4% TMC; end graft 90-99/1-10 GLY/CAP; or
central block 3-5% TMC; end graft 90-99/1-10 GLY/CAP; or
central block 4-6% TMC; end graft 90-99/1-10 GLY/CAP; or
central block 5-7% TMC; end graft 90-99/1-10 GLY/CAP; or
central block 6-8% TMC; end graft 90-99/1-10 GLY/CAP; or
central block 7-9% TMC; end graft 90-99/1-10 GLY/CAP; or
central block 8-10% TMC; end graft 90-99/1-10 GLY/CAP;
where, in each of the above, 90-99/1-10 GLY/CAP may optionally be replaced with 93-97/3-7 GLY/CAP; or 90-95/5-10 GLY/CAP.

In one embodiment, the triaxial polymer may be described by
central block 1-10% TMC; end graft 70-80/20-30 GLY/CAP; or
central block 1-3% TMC; end graft 70-80/20-30 GLY/CAP; or
central block 2-4% TMC; end graft 70-80/20-30 GLY/CAP; or
central block 3-5% TMC; end graft 70-80/20-30 GLY/CAP; or
central block 4-6% TMC; end graft 70-80/20-30 GLY/CAP; or
central block 5-7% TMC; end graft 70-80/20-30 GLY/CAP; or
central block 6-8% TMC; end graft 70-80/20-30 GLY/CAP; or
central block 7-9% TMC; end graft 70-80/20-30 GLY/CAP; or
central block 8-10% TMC; end graft 70-80/20-30 GLY/CAP;
where, in each of the above, 70-80/20-30 GLY/CAP may optionally be replaced with 72/28 GLY/CAP.

In one embodiment, the triaxial polymer may be described by
central block 1-10% TMC; end graft 80-99/1-20 GLY/TMC; or
central block 1-3% TMC; end graft 80-99/1-20 GLY/TMC; or
central block 2-4% TMC; end graft 80-99/1-20 GLY/TMC; or
central block 3-5% TMC; end graft 80-99/1-20 GLY/TMC; or
central block 4-6% TMC; end graft 80-99/1-20 GLY/TMC; or
central block 5-7% TMC; end graft 80-99/1-20 GLY/TMC; or
central block 6-8% TMC; end graft 80-99/1-20 GLY/TMC; or
central block 7-9% TMC; end graft 80-99/1-20 GLY/TMC; or
central block 8-10% TMC; end graft 80-99/1-20 GLY/TMC;
where, in each of the above, end graft 80-99/1-20 GLY/TMC may optionally be replaced with end graft 88-92/8-12 GLY/TMC.

In one embodiment, the triaxial polymer may be described by
central block 1-10% TMC; end graft 85-95/5-15 GLY/TMC; or
central block 1-3% TMC; end graft 85-95/5-15 GLY/TMC; or
central block 2-4% TMC; end graft 85-95/5-15 GLY/TMC; or
central block 3-5% TMC; end graft 85-95/5-15 GLY/TMC; or
central block 4-6% TMC; end graft 85-95/5-15 GLY/TMC; or
central block 5-7% TMC; end graft 85-95/5-15 GLY/TMC; or
central block 6-8% TMC; end graft 85-95/5-15 GLY/TMC; or
central block 7-9% TMC; end graft 85-95/5-15 GLY/TMC; or
central block 8-10% TMC; end graft 85-95/5-15 GLY/TMC;
where, in each of the above, end graft 85-95/5-15 GLY/TMC may optionally be replaced with end graft 88-92/8-12 GLY/TMC.

In one embodiment, the triaxial polymer may be described by:
1-10/15-25/20-30/45-55 GLY/CAP/TMC/GLY; or
2-9/16-24/21-29/46-54 GLY/CAP/TMC/GLY; or
3-8/16-23/21-28/48-54 GLY/CAP/TMC/GLY; or
3-7/17-21/22-26/50-54 GLY/CAP/TMC/GLY.

In one embodiment, the triaxial polymer may be described by:
central block 5-15% 80-90/10-20 CAP/LAC; end graft 90-99/1-10 LAC/GLY; or
central block 5-7% 80-90/10-20 CAP/LAC; end graft 90-99/1-10 LAC/GLY; or
central block 6-8% 80-90/10-20 CAP/LAC; end graft 90-99/1-10 LAC/GLY; or
central block 7-9% 80-90/10-20 CAP/LAC; end graft 90-99/1-10 LAC/GLY; or
central block 8-10% 80-90/10-20 CAP/LAC; end graft 90-99/1-10 LAC/GLY; or
central block 9-11% 80-90/10-20 CAP/LAC; end graft 90-99/1-10 LAC/GLY; or
central block 10-12% 80-90/10-20 CAP/LAC; end graft 90-99/1-10 LAC/GLY; or
central block 11-13% 80-90/10-20 CAP/LAC; end graft 90-99/1-10 LAC/GLY; or
central block 12-14% 80-90/10-20 CAP/LAC; end graft 90-99/1-10 LAC/GLY; or
central block 13-15% 80-90/10-20 CAP/LAC; end graft 90-99/1-10 LAC/GLY;
where, in each of the above, 80-90/10-20 CAP/LAC may optionally be replaced with 83-87/13-17 CAP/LAC and independently, end graft 90-99/1-10 LAC/GLY may optionally be replaced with 92-96/7-11 LAC/GLY.

In one embodiment, the triaxial polymer may be described by:
central block 15-25% PEG; graft 11-5% TMC; end graft 90-99/1-10 LAC/GLY; or
central block 15-17% PEG; graft 11-5% TMC; end graft 90-99/1-10 LAC/GLY; or
central block 16-18% PEG; graft 11-5% TMC; end graft 90-99/1-10 LAC/GLY; or
central block 17-19% PEG; graft 11-5% TMC; end graft 90-99/1-10 LAC/GLY; or
central block 18-20% PEG; graft 11-5% TMC; end graft 90-99/1-10 LAC/GLY; or
central block 19-21% PEG; graft 11-5% TMC; end graft 90-99/1-10 LAC/GLY; or
central block 20-22% PEG; graft 11-5% TMC; end graft 90-99/1-10 LAC/GLY; or
central block 21-23% PEG; graft 11-5% TMC; end graft 90-99/1-10 LAC/GLY; or
central block 22-24% PEG; graft 11-5% TMC; end graft 90-99/1-10 LAC/GLY; or
central block 23-25% PEG; graft 11-5% TMC; end graft 90-99/1-10 LAC/GLY; or
where, in each of the above, PEG refers to a polyethylene glycol and independently, graft 1 1-5% TMC refers to graft 1 1-2% TMC; and independently end graft 90-99/1-10 LAC/GLY refers to end graft 90-94/6-10 LAC/GLY.

In one embodiment, the triaxial polymer may be described by:
65-75/25-35/1-10 GLY/CAP/TMC; or
66-74/26-34/2-9 GLY/CAP/TMC; or
67-73/27-33/3-8 GLY/CAP/TMC; or
68-72/28-32/4-7 GLY/CAP/TMC; or
69-71/29-31/5-6 GLY/CAP/TMC.

In one embodiment, the triaxial polymer may be described by:
60-70/30-40 GLY/TMC; or
61-69/31-39 GLY/TMC; or
62-68/32-38 GLY/TMC; or
63-67/33-37 GLY/TMC; or
64-66/34-36 GLY/TMC.

In one embodiment, the triaxial polymer may be described by:
90-99/1-10/1-10 GLY/CAP/TMC; or
91-98/2-9/2-9 GLY/CAP/TMC; or
92-97/3-8/3-8 GLY/CAP/TMC; or 93-96/4-7/4-7 GLY/CAP/TMC.

In one embodiment, the triaxial polymer may be described by:
80-90/1-10/1-10 GLY/TMC/CAP; or
81-89/2-10/2-9 GLY/TMC/CAP; or
82-88/3-10/3-8 GLY/TMC/CAP; or
83-87/4-10/4-7 GLY/TMC/CAP.

In one embodiment, the triaxial polymer may be described by:
65-75/25-35/1-10 GLY/TMC/polypropylene succinate; or
66-74/25-33/1-8 GLY/TMC/polypropylene succinate; or
67-73/25-30/1-5 GLY/TMC/polypropylene succinate.

In one embodiment, the triaxial polymer may be described by:
30-40/30-40/15-25/10-20 CAP/LAC/GLY/TMC; or
31-39/31-39/15-23/11-19 CAP/LAC/GLY/TMC; or
32-38/32-38/15-21/12-18 CAP/LAC/GLY/TMC; or
32-37/32-37/15-19/12-16 CAP/LAC/GLY/TMC.

In one embodiment, the triaxial polymer may be described by:
35-45/35-45/25-35 LAC/CAP/TMC; or
36-44/36-44/25-34 LAC/CAP/TMC; or
37-43/36-43/25-33 LAC/CAP/TMC; or
37-42/36-42/25-32 LAC/CAP/TMC; or
37-41/36-41/25-31 LAC/CAP/TMC.

In one embodiment, the triaxial polymer may be described by:
35-45/25-35/20-30/1-10 LAC/CAP/TMC/GLY; or
36-44/26-34/21-29/1-9 LAC/CAP/TMC/GLY; or
37-43/27-33/22-28/1-8 LAC/CAP/TMC/GLY; or
38-42/28-32/24-27/1-6 LAC/CAP/TMC/GLY.

In one embodiment, the present disclosure provides a monofilament fiber comprising a polyaxial polymer of a formula M(B)₂ or M(B)₃. Optionally, the polyaxial polymer has the formula M(B)₂. Optionally, the polyaxial polymer has the formula M(B)₃. The M portion of the polyaxial polymer may be referred to as the prepolymer or the mid-block or the central block, while the B portions may be referred to as the arms or the end-grafts. Optionally, a polyaxial polymer of the formula M(B)₂ or M(B)₃ may be prepared by first forming the mid-block M, i.e., the pre-polymer, and then polymerizing monomers onto M, i.e., end-grafting, to provide M(B)₂ or M(B)₃. Polyaxial polymers are conveniently used to prepare monofilaments of the present disclosure because the properties of M and B may be independently selected based upon the choice of monomer(s) used to prepare M and the choice of monomer(s) used to prepare B. In one embodiment, the choice of monomers used to prepare M is different from the choice of monomers used to prepare B, so that the properties of M are different from the properties of B.

The M portion of the polyaxial polymer, which may also be referred to as the prepolymer portion of the polyaxial polymer of a formula M(B)₂ or M(B)₃, comprises a plurality of repeating units which are the polymerization product of one or both of trimethylene carbonate (TMC) and epsilon-caprolactone (CAP). In other words, trimethylene carbonate and epsilon-caprolactone are monomers that are polymerized to form M. Optionally, these two monomers are copolymerized, so that the repeating units in M are the polymerization product, also referred to as the residue, of trimethylene carbonate and the polymerization product or residue of epsilon-caprolactone. In one embodiment, on a molar basis, the majority of the repeating units in M are the residues from trimethylene carbonate and/or epsilon-caprolactone. In other embodiments, more than 50 mol %, or at least 50 mol %, or at least 55 mol %, or at least 60 mol %, or at least 65 mol %, or at least 70 mol %, or at least 75 mol %, or at least 80 mol %, or at least 85 mol %, or at least 90 mol %, or at least 95 mol % of the repeating units in M are the residues from trimethylene carbonate and/or epsilon-caprolactone. The present disclosure provides that any two of these mol % values may be combined to provide a range, e.g., 80 mol % and 90 mol % may be combined to provide the range of 80 mol %-90 mol %. As mentioned, in one embodiment, the stated mol % is formed from a mixture of CAP and TMC residues, i.e., M is a copolymer rather than a homopolymer of residues of TMC and CAP, for example, 80 mol %-90 mol % of the repeating units in M may be residues from both of TMC and CAP.

In M as mentioned above, while the majority of the repeating units may derive from the monomers TMC and/or CAP, in an optional embodiment not all of the repeating units in M derive from TMC or CAP. In one embodiment, a majority of the repeating units derive from TMC and/or CAP, but at least 3 mol % of the repeating units are not the polymerization product of TMC or CAP, while in other embodiments, at least 5 mol %, or at least 8 mol %, or at least 10 mol %, or at least 15 mol % of the repeating units do not derive from TMC or CAP, but optionally derive from one or more of glycolide (GLY) and lactide (LAC). For example, in one embodiment, the repeating units in M are 80-95 mol % derived from TMC and/or CAP, and the remaining 5-20 mol % are derived from LAC and/or GLY. In one embodiment, the repeating units in M are 85-95 mol % derived from TMC and/or CAP, and the remaining 5-15 mol % are derived from LAC and/or GLY. In one embodiment, the repeating units in M are 85-90 mol % derived from TMC and/or CAP, and the remaining 5-10 mol % are derived from LAC and/or GLY. In one embodiment, between 1 and 20 mol % of the repeating units in M are a polymerization product of at least one of glycolide and lactide.

In one embodiment, at least 70 mol % of the repeating units in M are a polymerization product of at least one of trimethylene carbonate and epsilon-caprolactone. In another embodiment, at least 70 mol % of the repeating units in M are a copolymerization product of both of trimethylene carbonate and epsilon-caprolactone, so that M is a copolymer. Optionally, the remaining repeating units in M are the residue from the polymerization of one or both of glycolide and lactide. In one embodiment, M is a copolymer formed from residues of monomers selected from TMC and/or CAP, and further including at least one of LAC and GLY. For example, M may be a copolymer of TMC, CAP and LAC derived repeating units. As another example, M may be a copolymer of TMC, CAP and GLY derived repeating units. As another example, M may be a copolymer of TMC and LAC derived repeating units. As another example, M may be a copolymer of TMC and GLY derived repeating units. As another example, M may be a copolymer of CAP and LAC derived repeating units. As another example, M may be a copolymer of CAP and GLY repeating units.

The B portion of the polyaxial polymer of a formula M(B)₂ or M(B)₃, which may also be referred to as the arms or end-graft portion of the polyaxial polymer, comprises a plurality of repeating units which are the polymerization product of one or both of glycolide (GLY) and lactide (LAC). In other words, GLY and LAC are monomers that are polymerized to form B. Optionally, these two monomers are copolymerized, so that the repeating units in B are the polymerization product, also referred to as the residue, of GLY and the polymerization product or residue of LAC. In one embodiment, on a molar basis, the majority of the repeating units in B are the residues from LAC and/or GLY. In other embodiments, at least 55 mol %, or at least 60 mol %, or at least 65 mol %, or at least 70 mol %, or at least 75 mol %, or at least 80 mol %, or at least 85 mol %, or at least 90 mol %, or at least 95 mol % of the repeating units in B are the residues from GLY and/or LAC. The present disclosure provides that any two of these mol % values may be combined to provide a range, e.g., 80 mol % and 90 mol % may be combined to provide the range of 80 mol %-90 mol %. As mentioned, in one embodiment, the stated mol % is formed from a mixture of LAC and GLY residues, i.e., B is a copolymer rather than a homopolymer of residues of GLY and LAC, for example, 80 mol %-90 mol % of the repeating units in B may be residues from both of GLY and LAC. However, in one embodiment, only LAC polymerization residues are present in B, while in another embodiment, only GLY polymerization residues are present in B.

In B as mentioned above, while the majority of the repeating units may derive from the monomers GLY and/or LAC, in an optional embodiment not all of the repeating units in B derive from GLY or LAC. In one embodiment, a majority of the repeating units derive from LAC and/or GLY, but at least 3 mol % of the repeating units are not the polymerization product of GLY or LAC, while in other embodiments, at least 5 mol %, or at least 8 mol %, or at least 10 mol %, or at least 15 mol % of the repeating units do not derive from LAC or GLY, but optionally derive from one or more of trimethylene carbonate (TMC) and epsilon-caprolactone (CAP). For example, in one embodiment, the repeating units in B are 80-95 mol % derived from GLY and/or LAC, and the remaining 5-20 mol % are derived from TMC and/or CAP. In one embodiment, the repeating units in B are 85-95 mol % derived from GLY and/or LAC, and the remaining 5-15 mol % are derived from TMC and/or CAP. In one embodiment, the repeating units in B are 85-90 mol % derived from GLY and/or LAC, and the remaining 5-10 mol % are derived from TMC and/or CAP. In one embodiment, between 1 and 20 mol % of the repeating units in B are a polymerization product of at least one of trimethylene carbonate and epsilon-caprolactone.

In one embodiment, at least 70 mol % of the repeating units in B are a polymerization product of at least one of lactide and glycolide. Optionally, the polymerization product of only one of LAC and GLY is present in B. In another embodiment, at least 70 mol % of the repeating units in B are a copolymerization product of both of GLY and LAC, so that B is a copolymer. Optionally, the remaining repeating units in B are the residue from the polymerization of one or both of TMC and CAP. In one embodiment, B is a copolymer formed from residues of TMC and GLY. In one embodiment, B is a copolymer formed from residues of TMC and LAC. In one embodiment, B is a copolymer formed from residues of CAP and GLY. In one embodiment, B is a copolymer formed from residues of CAP and LAC.

In one embodiment, the monofilament is made from a polyaxial polymer as described herein, where the polymer is in a semi-crystalline form. The polymer advantageously has some crystallinity in order that, upon being exposed to elevated temperature in the print head of the additive manufacturing printer, the heat of the print head is not unduly consumed by converting amorphous polymer to crystalline polymer. In other words, if the polymer is already in a semi-crystalline form upon entering the print head, then less heat from the print head is consumed in converting amorphous polymer to crystalline polymer. Because print heads typically have limited thermal energy, if too much heat from the print head is needed to convert amorphous polymer to crystalline polymer, then there is not enough heat left in the print head to convert the monofilament to a molten form needed to be deposited to form the printed part. In one embodiment, polyaxial polymers M(B)₂ and M(B)₃ of the present disclosure in a monofilament form are semi-crystalline.

Optionally, the majority of the mass of the polyaxial polymer is contributed by B and the minority of the mass of the polyaxial polymer is contributed by M. For example, in one embodiment, M contributes less than 50 wt % of the weight of the polyaxial polymer while B contributes greater than 50 wt % of the weight of the polyaxial polymer. In one embodiment, M contributes at least 10 wt %, or at least 15 wt % of the weight of the polyaxial polymer, but less than 50 wt %. In one embodiment, B contributes no more than 90 wt %, or no more than 85 wt %, but more than 50 wt %.

Thus, in one embodiment, the present disclosure provides a monofilament fiber comprising a polyaxial polymer of a formula M(B)₂ or M(B)₃, where M comprises repeating units and B comprises repeating units, where a majority of the repeating units in M are the polymerization residues from TMC and/or CAP and a minority of the repeating units in M are the polymerization residues from CAP and/or GLY, while in contrast, a majority of the repeating units in B are the polymerization residues from GLY and/or LAC and a minority of the repeating units in B are the polymerization residues from TMC and/or CAP. In this way, the mid-block M has properties resulting primarily from the presence of residues of TMC and/or CAP, influenced by a minor amount of the residues from LAC and/or GLY, while the end grafts B have properties resulting primarily from the presence of residues of LAC and/or GLY, influenced by a minor amount of the residues from TMC and/or CAP.

The present disclosure provides monofilament fibers containing these polyaxial polymers of the formula M(B)₂ or M(B)₃, as well as assemblies and kits containing the monofilament fibers, and their use in additive printing. For example, the present disclosure provide the following exemplary numbered embodiments:
1) A kit comprising an assembly located inside of a pouch, the assembly comprising a monofilament fiber that is wound around a spool, the monofilament fiber comprising a polyaxial polymer of a formula M(B)₂ or M(B)₃, where:
   a. M is a homopolymer or a copolymer and comprises a plurality of repeating units, where a majority, e.g., at least 70 mol % of the repeating units in M are a polymerization product of at least one of trimethylene carbonate and epsilon-caprolactone, where optionally M is a copolymerization product of at least one of trimethylene carbonate and epsilon-caprolactone, and at least one of lactide and glycolide; and
   b. B comprises a plurality of repeating units, where a majority, e.g., at least 70 mol % of the repeating units in B are a polymerization product of at least one of glycolide and lactide.
2) The kit of embodiment 1 wherein the spool is stable up to a temperature of at least 90° C.
3) The kit of any of embodiments 1-2 wherein the pouch has a moisture vapor transmission rate (MVTR) of less than 0.002 g water/100 in²/24 hrs.
4) The kit of any of embodiments 1-2 wherein the pouch is a hermetically sealed pouch.
5) The kit of any of embodiments 1-2 wherein the pouch comprises multiple layers, at least one of the multiple layers comprising a metal foil.
6) The kit of any of embodiments 1-5 wherein the monofilament fiber comprises a monomer content of less than 2 wt %.
7) The kit of any of embodiments 1-6 wherein the monofilament fiber is undrawn.
8) The kit of any of embodiments 1-7 wherein the monofilament fiber has an orientation factor of less than 50%.
9) The kit of any of embodiments 1-8 wherein the monofilament fiber is essentially circular in section, and the cross section has a diameter of 1.6 mm to 3.1 mm.
10) The kit of any of embodiments 1-9 wherein the monofilament fiber has a weight of 50 grams to 1,500 grams.
11) The kit of any of embodiments 1-10 wherein the monofilament fiber is solid at ambient temperature but fluid at an elevated temperature, where the fluid has a MFI value of between about 2.5-30 grams per 10 minutes, where the elevated temperature is an operating temperature of an additive manufacturing process.
12) The kit of any of embodiments 1-11 wherein the polyaxial polymer is USP Class VI biocompatible.
13) The kit of any of embodiments 1-12 wherein the polyaxial polymer has the formula M(B)₃.
14) The kit of any of embodiments 1-12 wherein the polyaxial polymer has the formula M(B)₂.
15) The kit of any of embodiments 1-14 wherein M provides at least 10 wt % of the weight of the polymer.
16) The kit of any of embodiments 1-15 wherein B provides at least 50 wt % of the weight of the polymer.
17) The kit of any of embodiments 1-16 wherein between 1 and 20 mol % of the repeating units in M are a polymerization product of at least one of glycolide and lactide.
18) The kit of any of embodiments 1-17 wherein between 1 and 20 mol % of the repeating units in B are a polymerization product of at least one of trimethylene carbonate and epsilon-caprolactone.
19) The kit of any of embodiments 1-18 wherein M comprises repeating units from trimethylene carbonate and epsilon-caprolactone.
20) The kit of any of embodiments 1-19 further comprising instructions for using the assembly in a method of additive manufacturing.
21) An assembly comprising a monofilament fiber wound around a spool, the monofilament fiber comprising a polyaxial polymer of a formula M(B)₂ or M(B)₃, where M comprises a plurality of repeating units from first monomer polymerization, where at least 70 mol % of the repeating units in M are a polymerization product of at least one of trimethylene carbonate and epsilon-caprolactone, where B comprises a plurality of repeating units from second monomer polymerization, where at least 70 mol % of the repeating units in B are a polymerization product of at least one of glycolide and lactide.
22) The assembly of embodiment 21 wherein the spool is stable up to a temperature of at least 90° C.
23) The assembly of any of embodiments 21-22 wherein the monofilament fiber comprises a monomer content of less than 2 wt %.
24) The assembly of any of embodiments 21-23 wherein the monofilament fiber is undrawn.
25) The assembly of any of embodiments 21-24 wherein the monofilament fiber has an orientation factor of less than 50%.
26) The assembly of any of embodiments 21-25 wherein the monofilament fiber is essentially circular in section, and the cross section has a diameter of 1.6 mm to 3.1 mm.
27) The assembly of any of embodiments 21-26 wherein the monofilament fiber has a weight of 50 grams to 1,500 grams.
28) The assembly of any of embodiments 21-27 wherein the monofilament fiber is solid at ambient temperature but fluid at an elevated temperature, where the fluid has a MFI value of between about 2.5-30 grams per 10 minutes, where the elevated temperature is an operating temperature of an additive manufacturing process.
29) The assembly of any of embodiments 21-28 wherein the polyaxial polymer is USP Class VI biocompatible.
30) The assembly of any of embodiments 21-29 wherein the polyaxial polymer has the formula M(B)₃.
31) The assembly of any of embodiments 21-29 wherein the polyaxial polymer has the formula M(B)₂.
32) The assembly of any of embodiments 21-31 wherein M provides at least 10 wt % of the weight of the polymer.
33) The assembly of any of embodiments 21-32 wherein B provides at least 50 wt % of the weight of the polymer.
34) The assembly of any of embodiments 21-33 wherein between 1 and 20 mol % of the repeating units in M are a polymerization product of at least one of glycolide and lactide.
35) The assembly of any of embodiments 21-34 wherein between 1 and 20 mol % of the repeating units in B are a polymerization product of at least one of trimethylene carbonate and epsilon-caprolactone.
36) The assembly of any of embodiments 21-35 wherein M comprises repeating units from trimethylene carbonate and epsilon-caprolactone.
37) A monofilament fiber comprising a polyaxial polymer of a formula M(B)₂ or M(B)₃, where M comprises a plurality of repeating units from first monomer polymerization, where at least 70 mol % of the repeating units in M are a polymerization product of at least one of trimethylene carbonate and epsilon-caprolactone, where B comprises a plurality of repeating units from second monomer polymerization, where at least 70 mol % of the repeating units in B are a polymerization product of at least one of glycolide and lactide.
38) The monofilament fiber of embodiment 37 wherein the monofilament fiber comprises a monomer content of less than 2 wt %. 39) The monofilament fiber of any of embodiments 37-38 wherein the monofilament fiber is undrawn.
40) The monofilament fiber of any of embodiments 37-39 wherein the monofilament fiber has an orientation factor of less than 50%,
41) The monofilament fiber of any of embodiments 37-40 wherein the monofilament fiber is essentially circular in section, and the cross section has a diameter of 1.6 mm to 3.1 mm.
42) The monofilament fiber of any of embodiments 37-40 wherein the monofilament fiber is solid at ambient temperature but fluid at an elevated temperature, where the fluid has a MFI value of between about 2.5-30 grams per 10 minutes, where the elevated temperature is an operating temperature of an additive manufacturing process.
43) The monofilament fiber of any of embodiments 37-42 wherein the polyaxial polymer is USP Class VI biocompatible.
44) The monofilament fiber of any of embodiments 37-43 wherein the polyaxial polymer has the formula M(B)₃.
45) The monofilament fiber of any of embodiments 37-43 wherein the polyaxial polymer has the formula M(B)₂.
46) The monofilament fiber of any of embodiments 37-45 wherein M provides at least 10 wt % of the weight of the polymer.
47) The monofilament fiber of any of embodiments 37-46 wherein B provides at least 40 wt % of the weight of the polymer.
48) The monofilament fiber of any of embodiments 37-47 wherein between 1 and 20 mol % of the repeating units in M are a polymerization product of at least one of glycolide and lactide.
49) The monofilament fiber of any of embodiments 37-48 wherein between 1 and 20 mol % of the repeating units in B are a polymerization product of at least one of trimethylene carbonate and epsilon-caprolactone.
50) The monofilament fiber of any of embodiments 37-49 wherein M comprises repeating units from trimethylene carbonate and epsilon-caprolactone.
51) A method of additive manufacturing, the method comprising:
   a. melting the monofilament fiber of any of embodiments 37-50 to provide a molten form of the fiber;
   b. depositing the molten form to provide an initial article; and
   c. cooling the initial article to room temperature to form a solid 3-dimensional article.
52) A method of additive manufacturing, the method comprising:
   a. Installing the assembly of any of embodiments 21-36 in an additive manufacturing printer;
   b. melting the monofilament fiber in the printer to provide a molten form of the fiber;
   c. depositing the molten form to provide an initial article; and
   d. cooling the initial article to room temperature to form a solid 3-dimensional article.

### Melting Point

The monofilament compositions of the present disclosure are thermoplastic in that they are solid at room temperature, may be heated to reach a fluid molten state, and will return to a solid state upon cooling. In one embodiment, the compositions of the present disclosure are solid at ambient temperature, e.g., 20-25° C., but fluid at an elevated temperature which is the operating temperature of an additive manufacturing process. Different additive manufacturing process utilize different operating temperatures, which typically fall within the range of 50-450° C. In various embodiments, the compositions of the present disclosure become fluid at a temperature which may be referred as the melting point of the composition, where depending on the composition, that melting point is greater than about 50° C., or about 75° C., or about 100° C., or about 125° C., or about 150° C., or about 175° C., or about 200° C., or about 225° C., or about 250° C., or about 275° C., or about 300° C., or about 325° C., or about 350° C., or about 375° C., or about 400° C., or about 425° C., or about 450° C., including ranges thereof. For example, in one embodiment the compositions of the present disclosure have a melting point of greater than about 50° C., e.g., about 50-100° C., or about 50-150° C., or about 50-200° C. In another embodiment, the compositions of the present disclosure have a melting point of greater than about 75° C., e.g., about 75-125° C., or about 75-150° C., or about 75-175° C., or about 75-200° C., or about 75-225° C. As used herein, a temperature of “about X”, where X is a stated temperature, refers to stated temperature X±5° C. of temperature X, i.e., the stated temperature ±5° C. of the stated temperature.

The melting point of a composition of the present disclosure may be measured according to ASTM or ISO standardized procedures. For instance, ASTM D7138-16 may be used to determine the melting temperature of synthetic fibers. As another example, ASTM D3418 describes the use of differential scanning calorimetry (DSC) to measure melting point.

### Melt Flow Index

When the monofilament composition is in a molten state, e.g., above its melting point, it may be characterized in terms of its melt flow properties, e.g., its Melt Flow Index (MFI) or Melt Flow Rate (MFR). A useful test to measure the ability for a material to flow is Melt Flow Index (MFI). This test can be applied to viscous fluids comprising crystalline, semi-crystalline, or amorphous thermoplastic materials to determine flow rate of a material under a given condition of temperature and pressure, typically provided as a weight (in grams) per time (in minutes) that a certain composition flows through a given orifice size. This test is a non-specific analysis of the ability of a material to flow, and is useful to determine the effect of temperature or pressure on the composition. For FFF and FDM, it is desirable to determine a temperature range suitable for generating an MFI value of between about 2.5-30 grams per 10 minutes, which translates to preferred FFF or FDM process temperatures for a given composition.

ASTM and ISO publish standardized procedures for measuring melt flow. See, e.g., ISO 1133, JIS K 7210, ASTM D1238 as general methods. In one embodiment, melt flow is measured according to ISO-1122-1 Procedure A. In another embodiment, melt flow is measured according to ASTM A1238 Procedure A. In another embodiment, melt flow is measured according to ISO 1122-2. In another embodiment, melt flow is measured according to ASTM D1238. The Instron Company (Norwood, MA, USA) sells instruments that can be used to measure melt flow according to these procedures, e.g., their CEAST Melt Flow Testers MF10, MF20, and MF30 models. Zwick Roell AG (Ulm, Germany) is another company that manufactures and sells suitable melt flow testers.

Thus, the compositions of the present disclosure may optionally be characterized in terms of their MFI. MFI generally corresponds to how viscous the fluid composition is, where a higher MFI is a less viscous composition. For additive manufacturing, a wide range of composition viscosities can be utilized, however, certain MFI values are particularly suitable and are provided by the compositions of the present disclosure. In one embodiment, the compositions of the present disclosure have a MFI of about 2.5-30 g/10 min at a temperature above the melt temperature of the composition and within the operating temperature of the additive manufacturing process, e.g., FFF. In various embodiments, the compositions of the present disclosure are characterized by a MFI in grams, as measured over a 10 minute period, of about 2.5-30, or about 2.5-25, or about 2.5-20, or about 2.5-15, or about 2.5-10, or about 5-30, or about 5-25, or about 5-20, or about 5-15, or about 10-30, or about 10-25, or about 10-15, or about 15-30, or about 15-25, or about 15-20, or about 20-30, or about 25-30. As used herein, about X-Y grams refers to each of X and Y±10%, e.g., about 2.5 refers to 2.25-2.75, while about 30 refers to 27-33 grams.

In one aspect, the present disclosure provides filaments that have size and properties which facilitate their use in additive manufacturing. As discussed in detail herein, those filaments may be characterized by their size, including multiplicity, diameter and length, and/or their properties including tensile modulus, crystallinity and flexibility.

### Multiplicity

In general, filaments may be mono-filaments or multi-filaments. A monofilament is a thread made from a single filament, while a multi-filament is a thread that is made by weaving together two or more filaments to create a bi-filament, tri-filament, etc., depending on how many filaments are used to form the multi-filament.

The filaments of the present disclosure may be characterized as being monofilaments. Thus, the filament does not have multiple filaments wound or braided together to form a multi-filament form. Instead, the filament is a single filament, also known as a mono-filament or a monofilament.

### Cross-Section

In one embodiment, the filament has a circular cross-section, i.e., the filament is round. As such, the filament may be described as having a diameter. In one embodiment, the diameter of the monofilament is within the range of 1.5 to 3.5 mm. In one embodiment the diameter is 1.75 mm. In another embodiment the diameter is 3.0 mm. In one embodiment the diameter does not vary by very much along the length of the filament. For example, the diameter may be selected from a value within the range of 1.5-3.5 mm, and the diameter variation is characterized as being no more than ±0.1 mm along the length of the monofilament. In one embodiment, the diameter does not vary by more than 0.1 mm, e.g., the diameter may be described as 3.0±0.1 mm. In another embodiment the diameter does not vary by more than 0.05 mm, e.g., the diameter may be described as 1.75±0.05 mm.

### Mass and Length

In one embodiment the filaments are cut into a useful length, the useful length corresponding to a useful mass. A useful mass of monofilament of the present disclosure is about 50-1,500 grams for additive manufacturing. Parts printed by additive manufacturing may have various masses, where it is convenient that a length of monofilament provide sufficient mass to produce an entire part, but the length not be so long that the monofilament is kept in the printing machine for a long time before it is completely consumed. The monofilament in the printing machine is subject to degradation by, e.g., oxidation and hydrolysis, and so from a stability perspective it is preferred that the monofilament not be in the machine so long that an appreciable amount of degradation occurs. In view of these considerations, the present disclosure provides a single (unbroken) length of monofilament that weighs about 50-1,500; or 200-1,500, while in other embodiments the mass is about 800-1,200 grams, or about 1,000 grams, i.e., 950-1050 grams. The present disclosure provides a method of forming monofilament that includes cutting the monofilament into lengths which each provide a mass of about 1,000 grams.

The monofilaments of the present disclosure may be characterized by their length. In one embodiment, the length of monofilament is less than 500 meters. In one embodiment, the length of monofilament is less than 400 meters. In one embodiment the length of monofilament is within the range of 10-500 meters, and in another embodiment the length of monofilament is within the range of 10-400 meters. In one embodiment, the monofilament length is 250-350 meters.

### Tensile Modulus

A filament of the present disclosure may be characterized by its tensile modulus. A suitable Young's modulus is at least 3 MPa and up to 4 GPa or more. The lower limit is suitable for manufacturing parts having a higher elasticity and compliance, which is desired for many interfaces and tissue contacting structures. Higher modulus materials are selected for structural performance in high strength applications.

### Crystallinity

A filament of the present disclosure may be characterized by its crystallinity. A variety of total material crystallinity may be useful in various products, with low crystallinity materials typically associated with softer, higher compliance materials such as elastomers. These materials may exhibit a total crystallinity of <5%. Highly crystalline materials, such as PLLA or PEEK, may be useful in creation of rigid support structures where structural and mechanical strength is critical.

Another useful characterization of crystallinity is related to the presence of crystalline orientation along the fiber axis. Most typically, structural and textile monofilaments are used as an oriented yarn to maximize tensile strength, which is an important consideration for the design and utility of a particular monofilament. Orientation is formed after monofilament extrusion through a series of heating and pulling processes to align crystallites along the filament axis (also referred to as “drawing”), thereby increasing the strength and stiffness of the fiber in that direction, while having a concomitant effect of reducing mechanical properties in the transverse filament direction. In one embodiment, the monofilaments of the present disclosure may be characterized as being “not drawn” or “undrawn” in that they have not gone through a drawing process and therefore do not have the enhanced crystallinity which is created by a drawing process. There are several techniques to measure crystalline orientation, such as wide-angle X-ray diffraction, birefringence, linear dichroism, and in a technique specifically useful in fibers, the acoustic velocity, among others.

Acoustic velocity correlates the degree of drawing with relative speed of sound through the filament, reported as an orientation factor (OF). OF is reported in various ways. OF may be measured on a “0” to “1” scale, with “0” indicating no orientation and “1” indicating total crystalline orientation. Sometimes OF is reported as a percentage, i.e., from 0 to 100%, rather than from 0 to 1. In some instances, OF is reported as a multiple of an unoriented sample, e.g., 1.5 times the velocity of an unoriented control. However, in general, OF is a measure of the degree of molecular orientation or alignment of the polymer chains in a fiber or filament, where a higher number or higher percentage reflects a higher degree of alignment.

In many textile filaments, orientation factor can and desirably does exceed 0.75, 0.85, 0.90, and in some cases 0.95. Conversely, monofilaments used in additive manufacturing processes according to the present disclosure do not have the same tensile requirements and instead benefit from mechanical isotropy, along with a typically lower energy typically required to melt unoriented filaments. In the monofilaments of the present disclosure there may be some low degree of orientation as a result of the extrusion process, but since the monofilament is undrawn, the orientation factor of the monofilament is relatively low, e.g., less than 0.50, 0.40, 0.30, 0.20 or 0.10.

A relatively low OF is advantageous for filaments of the present disclosure suitable for a melt extrusion process such as FFF because lower orientation generally means less crystallinity, and that in turn means that less heat is needed to convert the monofilament into a liquid state, and that the heat which is applied to the monofilament can more quickly and efficiently convert a solid filament into a liquid state suitable for 3D printing. Accordingly, in one embodiment, the monofilament of the present disclosure has an orientation factor of less than 50%, while in another embodiment the monofilament has an orientation factor of less than 40%, and in another embodiment the monofilament has an orientation factor of less than 30%, while in yet another embodiment the monofilament has an orientation factor of less than 20%, and in still another embodiment the monofilament has an orientation factor of less than 10%. In each of these embodiments the monofilament may be further characterized as being an undrawn monofilament.

### Flexibility

The filaments of the present disclosure may be characterized by their flexibility. A monofilament should not be so rigid (inflexible) that it breaks or fractures when it is wound around a spool. Conversely, the monofilament should not be so flexible that it will not move forward when a trailing portion of monofilament is pushed forward. In other words, when a length of monofilament is laid flat and in a straight line on a surface, and the proximal end of the monofilament is pushed in the direction of the distal end of the monofilament, the distal end of the monofilament should move forward the same distance as the proximal end is pushed forward. If the solid monofilament is too flexible it will not have the stiffness to push molten monofilament out of the heating chamber.

As a measure of the ability of a filament to push itself through a printer, a column buckling test may be performed, where this test measures the buckling resistance, also sometimes referred to as the buckling strength, of the filament in response to axial compression.

In a buckling test performed on a filamentous material, the material is placed in a vertical direction and clamped above and below the region of the filament that will be tested for buckling strength. A monofilament of the present disclosure may be held in place using two lengths of Bowden tube that run along and share a single longitudinal axis, where there is a 1 cm gap between an end of one Bowden tube and an end of another Bowden tube. A length of monofilament is placed within the two Bowden tubes, providing an interstitial monofilament, such that 1 cm of interstitial monofilament which lies between the two tubes is unsupported and exposed to ambient conditions. A Bowden tube is found on many FFF printing devices, and is a cylinder having an inner diameter of about 2.0 mm, where the monofilament having a width of about 1.75 mm needs to travel through the Bowden tube during the printing process. A mechanical test frame may be employed to move the two pieces of Bowden tubing closer together to thereby observe the effect of axial compression on the interstitial filament, while capturing load and displacement information during the test.

During the buckling test performed on various filaments, the resistance (load) increases in the fiber direction until a peak, at which point the buckling is so significant that the monofilament bends and behaves somewhat like a hinge, at which point the load begins to decrease. This transition from resistance to buckling typically occurs within the first 5 mm of axial compression. After this peak resistance is reached, it is easier for the filament to kink/bend rather than push against the applied compressive force.

Using the column buckling test, a study was performed using monofilaments with good printability in a 3D printing process, as well as sample materials that either printed poorly or cannot be printed with existing printers that employ a Bowden tube or operate as direct drive printers. This test identified a preferred minimum load correlating with a “printable” monofilament, where that value is at least 1 Newton. Monofilaments which exhibit little or no resistance to the moving together of the two ends of the Bowden tubes, i.e., measuring less than about 1 Newton in this column buckling test, had trouble being utilized in a printer using a Bowden tube as well as direct drive printers. This failure to adequately perform was due to low filament stiffness resulting in column buckling and filament misfeeds.

Accordingly, in one embodiment, the monofilament of the present disclosure exhibits at least 1 Newton of resistance when tested by a column buckling test. The monofilaments of the present disclosure may be characterized as having a buckling strength of at least 1 Newton. In another embodiment, the monofilament of the present disclosure exhibits at least 1 Newton of resistance when forces are applied along the longitudinal axis of a 1 cm length of the monofilament. In one embodiment, a 1 cm length of monofilament of the present disclosure, having a width or diameter of 1.5-3.0 mm, e.g., 1.75±0.05 mm, exhibits at least 1 Newton of resistance when tested by this column buckling test. In another embodiment, a 1 cm length monofilament of the present disclosure, having a width or diameter of 1.5-3.0 mm, e.g., 1.75±0.05 mm, exhibits at least 1 Newton of resistance when forces are applied along the longitudinal axis of a 3 cm or longer length of the monofilament, where the 1 cm length is unconstrained and there is at least 1 cm of monofilament on either end of the unconstrained 1 cm of monofilament, where the unconstrained 1 cm of monofilament resists compression along its longitudinal axis.

### Water Content

In one aspect, the polyaxial polymer of the formula M(B)₂ or M(B)₃ is dehydrated to provide a low-moisture polymer, prior to being formed into a monofilament form. In various embodiments, the dehydration process achieves a polyaxial polymer having a moisture content of less than 100 ppm water, or less than 200 ppm water, or less than 300 ppm water, or less than 400 ppm water, or less than 500 ppm water, or less than 600 ppm water, or less than 700 ppm water, or less than 800 ppm water, or less than 900 ppm water. To achieve the dehydrated form of the polymer, the polymer may be ground to a powder form, and then placed in a vacuum oven, for a desired time and temperature and vacuum. Having a low moisture form of the polyaxial polymer is advantageous in forming monofilaments of the present disclosure because the presence of moisture can cause degradation of the polymer during the monofilament formation process.

### Monomer Content

The polyaxial polymers of the present disclosure are conveniently prepared from an initiator and monomers, where the monomers polymerize to provide repeating units of the M and B portions of the polyaxial polymers. After the production of the M(B)₂ or M(B)₃ polymer, there is typically some unreacted (unpolymerized) monomer in admixture with the desired polyaxial polymer. In one embodiment of the disclosure, the unreacted monomers are removed from contact with the polyaxial polymer. For example, the product mixture, or a portion thereof containing unreacted monomer and polyaxial polymer, may be placed in a vacuum oven at a suitable temperature and vacuum, for a suitable length of time, to evaporate the monomer and remove it from the polyaxial polymer. Alternatively, residual monomer may be removed using a solvent extraction process. In embodiments, there is less than 5 wt %, or less than 4 wt %, or less than 3 wt %, or less than 2 wt %, or less than 1 wt % of residual monomer in contact with the polyaxial polymer, in the monofilaments of the present disclosure. For example, in one embodiment the present disclosure provides a monofilament fiber that comprises a monomer content of less than 2 wt %. Such a monofilament fiber may be prepared from a polyaxial polymer as disclosed herein that has a monomer content of less than 2 wt %. The residual monomer is advantageously removed from the polyaxial polymer prior to monofilament formation because the presence of residual monomer in contact with the polyaxial polymer can cause degradation of the polyaxial polymer during the heating process whereby the polyaxial polymer is placed into a monofilament fiber form.

### Formulations

In one aspect, the present disclosure provides formulated compositions that are used to create monofilaments. A formulated composition contains a polymer as described herein, in admixture with one or more additive. The additive imparts desirable properties to the composition. Exemplary additives include antioxidants, stabilizers, viscosity modifiers, extrusion aids, lubricants, plasticizers, colorants and pigments, and active pharmaceutical ingredients. In some cases, the additive can contribute to more than one of the above-mentioned functions. In various embodiments, the sum of the additives, on a weight percent basis based on the total weight of the composition of polymer+additive, is less than 10 wt %, or less than 9 wt %, or less than 8 wt %, or less than 7 wt %, or less than 6 wt %, or less than 5 wt %, or less than 4 wt %, or less than 3 wt %, or less than 2 wt %, or less than 1 wt %.

Exemplary antioxidants, which may be used to minimize process and thermally induced oxidation include, e.g., primary antioxidants such as hindered phenols, and secondary antioxidants such as thioethers. Suitable antioxidants are biocompatible in the amounts used in the composition. For medical applications, biocompatible antioxidants are preferred, for example Vitamin E.

Exemplary colorants, which impart color to the manufactured part, are optionally biocompatible in the amounts used in the composition. For medical applications, biocompatible colorants are preferred. Exemplary biocompatible colorants include D&C Violet #2, D&C Blue #6, D&C Green #6, (phthalocyaninato(2-)) copper, and others as described in FDA 21 CFR Part 73 and 74. The colorant should be used in an amount effective to achieve the desired appearance, e.g., about at 0.05 wt % of D&C Violet #2 can be used to create violet-colored devices. In one embodiment, the colorant is an FDA approved colorant present in the composition at a concentration of 0.01-0.5 wt %, while in other embodiments the colorant concentration is 0.1-0.5 wt %, or 0.2-0.5 wt %, or 0.3-0.5 wt %, or 0.4-0.5 wt %. In one embodiment the colorant concentration does not exceed about 0.5 wt %.

Exemplary viscosity modifiers, which typically reduce the viscosity of a molten form of the composition, include oils, low molecular weight polymers and oligomers, monomers, and solvents. The use of viscosity modifiers reduces the energy requirement to melt the composition and allows for better flow and layer adhesion during the printing process. In one embodiment, PEG with a molecular weight of about 1,000 is included in the continuous phase at 0.5 wt %. When the major component of the continuous phase is poly(lactide), the addition of 0.5 wt % PEG with molecular weight of 1,000 provides a composition that is able to be processed through a FFF process at 15° C. less than a corresponding monofilament without the viscosity modifier. In one embodiment, the composition of the present disclosure contains a viscosity modifier which is a polyethylene glycol having a molecular weight of less than 5,000, where the viscosity modifier is present in the composition at a concentration of less than 1 wt % of the composition.

Various components can serve to increase the viscous flow of a composition, including plasticizers like oils, surfactants, organic solvents such as water, monomers, low molecular weight polymers, and oligomers. For the latter three, it is optional to have these remaining in a polymer as unreacted residuals and their presence may assist in downstream processing like extrusion or FFF printing.

Optionally, the additive may be in the form of a particulate. For instance, in some versions the particulates are identified as a microsphere with regular and smooth wall surface. These microspheres may be created, e.g., by emulsion processes or through a variety of other techniques used to create microspheres. Alternatively, the particulate could comprise a collection of irregular shaped particulates. The irregular shaped particulates can comprise particles with smooth surfaces, rough surfaces or a combination thereof. The particulates may comprise particles with jagged edges. Irregular shaped particulates may be generated through a milling technique such as jet milling, cryomilling or ball milling to reduce the particulate size to an application-appropriate diameter.

### Assemblies

The present disclosure provides articles that may be sold in commerce and which provide the purchaser with convenient access to compositions usefully employed in additive manufacturing processes. These articles may also be referred to as assemblies.

Monofilament described herein may be wound around a spool and used in additive manufacturing. A length of about 300-400 meters provides a mass of monofilament of about 1 kg. In one embodiment, the compositions, and accordingly the monofilaments, of the present disclosure have a density of about 1.4 g/cm³ and accordingly a monofilament length of about 250-350 meters is useful for placing on a spool and is provided according to one embodiment of the present disclosure.

In one embodiment, the monofilament of the present disclosure is wound around a spool to provide an exemplary assembly. The spool may be of the type that includes a core that supports the monofilament, and two flanges that together function to retain the monofilament on the core. In one aspect, the spool is stable up to a temperature of at least 90° C. In one aspect, the spools of the present disclosure are used in an additive manufacturing process wherein the spool is exposed to elevated temperature during the printing process. In order to maintain dimensional stability during the additive manufacturing process, the spool of the present disclosure may be stable up to a temperature of at least 90° C., or at least 100° C., or at least 110° C., or at least 120° C., or at least 130° C., or at least 140° C., or at least 150° C. If the spool is not sufficiently thermally stable, then the spool will undergo deformation at elevated temperature, where a deformed spool may interfere with the printing process, possibly to the point of completely stopping the printing process. Also, the spool should be stable to the release of plasticizers or other vapors that could contaminate the monofilament, e.g., the spool should not release organic vapors at elevated temperatures. Thus, in the kits and assemblies of the present disclosure, the spool may be thermally stable at least up to 90° C. Suitable materials to prepare spools for the assemblies and kits of the present disclosure include acrylonitrile butadiene styrene (ABS) copolymer, polycarbonate, and blends thereof.

As mentioned herein, the monofilaments of the present disclosure may be cut into lengths that provide about 1 kg of monofilaments, where the present disclosure provides a spool containing this amount of monofilament. In other embodiments, the spool contains any of the other cut amounts of monofilament as discussed herein.

In one embodiment, the present disclosure provides an assembly comprising a monofilament fiber wound around a spool, where the monofilament fiber comprises a triaxial polymer of the formula M(B)₃ where M is a polymerization product of a first monomer, the first monomer comprising at least one monomer selected from trimethylene carbonate and epsilon-caprolactone, and B is a polymerization product of a second monomer, the second monomer comprising at least one monomer selected from glycolide, lactide and caprolactone. Optionally, any one or more of the following criteria may be used to further describe the assembly: the spool is stable up to a temperature of at least 90° C.; the triaxial polymer is USP Class VI biocompatible; the triaxial polymer comprises a monomer content of less than 2 wt %; M of the triaxial polymer contributes at least 5 wt % of the total weight of the M(B)₃ polymer; B comprises a polymerization product of glycolide, lactide and caprolactone; the triaxial polymer has a Tg of less than 25° C.; the monofilament fiber is undrawn; the monofilament fiber has an orientation factor of less than 50%; the monofilament fiber is essentially circular in section, and the cross section has a diameter of 1.7 mm to 2.9 mm; the monofilament fiber has a weight of 50 grams to 1,500 grams; and the monofilament fiber is solid at ambient temperature but fluid at an elevated temperature, where the fluid has a MFI value of between about 2.5-30 grams per 10 minutes, where the elevated temperature is an operating temperature of an additive manufacturing process. For example, the present disclosure provides an assembly comprising a monofilament fiber wound around a spool, where the monofilament fiber comprises a triaxial polymer of the formula M(B)₃ where M is a polymerization product of a first monomer, the first monomer comprising at least one monomer selected from trimethylene carbonate and epsilon-caprolactone, and B is a polymerization product of a second monomer, the second monomer comprising at least one monomer selected from glycolide, lactide and caprolactone, where the spool is stable up to a temperature of at least 90° C., the triaxial polymer is USP Class VI biocompatible, the triaxial polymer comprises a monomer content of less than 2 wt %; M of the triaxial polymer contributes at least 5 wt % of the total weight of the M(B)₃ polymer, B comprises a polymerization product of glycolide, lactide and caprolactone; the monofilament fiber is undrawn; the monofilament fiber has an orientation factor of less than 50%; the monofilament fiber is essentially circular in section, and the cross section has a diameter of 1.7 mm to 2.9 mm.

In one embodiment, the present disclosure provides an assembly comprising a monofilament fiber wound around a spool, where the monofilament fiber comprises a polymer, the polymer selected from a linear polymer of the formula M(B)₂ and a triaxial polymer of the formula M(B)₃, wherein optionally M is a prepolymer having a Tg of less than 25° C., where M contributes at least 5 wt % of the total weight of the polymer. In another embodiment, the present disclosure provides an assembly comprising a monofilament fiber wound around a spool, where the monofilament fiber comprises a polymer, the polymer selected from a linear polymer of the formula M(B)₂ and a triaxial polymer of the formula M(B)₃, wherein optionally B is an end-graft polymer having a Tg of less than 25° C., where B contributes at least 5 wt % of the total weight of the polymer. Optionally, any one or more of the following criteria may be used to further describe either of these two embodiments: M is a prepolymer comprising a reaction product of a monomer selected from trimethylene carbonate and epsilon-caprolactone; B is an end-graft polymer comprising a reaction product of a monomer, where the monomer is selected from the group consisting of glycolide, lactide, trimethylene carbonate, epsilon-caprolactone and dioxanone; at least 50 molar percent of all residues in B are selected from the polymerization of monomers selected from trimethylene carbonate, epsilon-caprolactone and dioxanone; less than 100 molar percent of all residues in B are selected from the polymerization of monomers selected from glycolide and lactide. Optionally, the monofilament comprises a linear polymer of the formula M(B)₂ wherein M is a prepolymer comprising a reaction product of a monomer selected from trimethylene carbonate and epsilon-caprolactone, B is an end-graft polymer comprising a reaction product of a monomer selected from glycolide, lactide, trimethylene carbonate, epsilon-caprolactone and dioxanone, wherein at least 50 molar percent of all residues in B are selected from the polymerization of monomers selected from trimethylene carbonate, epsilon-caprolactone and dioxanone. Optionally, the monofilament comprises a polyaxial polymer of the formula M(B)₃ wherein M is a prepolymer comprising a reaction product of a monomer selected from trimethylene carbonate and epsilon-caprolactone, B is an end-graft polymer comprising a reaction product of a monomer selected from glycolide, lactide, trimethylene carbonate, epsilon-caprolactone and dioxanone, wherein at least 50 molar percent of all residues in B are selected from the polymerization of monomers selected from trimethylene carbonate, epsilon-caprolactone and dioxanone. In these embodiments, optionally M is a homopolymer comprising a polymerization product of trimethylene carbonate; or optionally M is a homopolymer comprising a polymerization product of epsilon-caprolactone; or optionally M is a copolymer comprising a polymerization product of trimethylene carbonate and epsilon-caprolactone. In these embodiments, optionally B comprises a polymerization product of glycolide, lactide and caprolactone. Optionally, M comprises a polymer having repeating units, where at 20 mol % of the repeating units are low- or non-crystallizable, where, e.g., the low- or non-crystallizable repeating units are the polymerization product from monomer selected from epsilon-caprolactone and trimethylene carbonate. In the assembly, the polymer of the monofilament may be a USP Class VI biocompatible polymer; and/or the polymer comprises a monomer content of less than 2 wt % (or other value as disclosed herein); and/or the monofilament fiber is undrawn; and/or the monofilament fiber has an orientation factor of less than 50%; and/or the monofilament fiber has a constant diameter within the range of 1.6 mm to 3.1 mm+/−0.1 mm; and/or the monofilament fiber on the spool has a weight of 50 grams to 1,500 grams. Optionally, in the two embodiments, the monofilament is solid at ambient temperature but fluid at an elevated temperature, the fluid having a MFI value of between about 2.5-30 grams per 10 minutes, the elevated temperature being an operating temperature of an additive manufacturing process. Optionally, in the two embodiments, the monofilament has a column buckling resistance of at least 1 Newton.

### Kits

In one embodiment, the present disclosure provides a kit comprising an assembly inside of a pouch, and optionally instructions for use. The assembly comprises a monofilament fiber wound around a spool as discussed herein. The instructions for use, when present, may disclose a use of the assembly in an additive manufacturing process. Optionally, the pouch may also contain some desiccant.

In one embodiment, the monofilament of the present disclosure is packaged and stored in a non-degradative environment. This is particularly important for monofilament that contains components that are susceptible to air- or moisture-induced degradation. Such monofilament includes bioabsorbable monofilament, i.e., monofilament made from a bioabsorbable material such as the M(B)₂ and M(B)₃ polyaxial polymers of the present disclosure, which are particularly susceptive to moisture-induced degradation. Whether or not the monofilament is bioabsorbable, it benefits from being stored in an inert atmosphere. Thus, the non-degradative environment may have one or both of controlled moisture content and controlled oxygen content. In one embodiment the storage conditions include a dry environment which has a controlled moisture content, where in various embodiments the moisture content is controlled to be less than 1,000 ppm water, or less than 800 ppm water, or less than 700 ppm water, or less than 600 ppm water, or less than 400 ppm water. The inert environment may be achieved by replacing ambient air with a nitrogen-enriched atmosphere. As another option, the inert environment may be achieved by placing the monofilament into an oxygen-impermeable package, and then sealing the package under reduced pressure. This approach also reduces the amount of moisture to which the monofilament would otherwise be exposed to during storage. Optionally, a desiccant such a packet of silica may be placed inside the packaging along with the monofilament.

The pouch of the present kits may be characterized as having a low moisture vapor transmission rate (MVTR) of equal to or less than 0.02 g/100 in²/24 hrs. Moisture vapor transmission rate, also known as water vapor transmission rate (WVTR), is a measure of the passage of water vapor through a substance, effectively a measure of the permeability for vapor barriers. MVTR may be measured according to ASTM F1249 or ASTM E96. In embodiments, the pouch of the kits of the present disclosure are selected to having an MVTR of equal to or less than 0.02 g/100 in²/24 hrs, or equal to or less than 0.002 g/100 in²/24 hrs, or equal to or less than 0.001 g/100 in²/24 hrs, or equal to or less than 0.0006 g/100 in²/24 hrs. These measurements are made at 100° F. and 90% relative humidity. The use of pouches having a low MVTR is valuable in the kits of the present disclosure when the monofilament fiber is formed from a moisture-sensitive polymer, such as M(B)₂ and M(B)₃ polymers of the present disclosure. In one embodiment, the pouch is a multi-layer pouch. In one embodiment, the multi-layer pouch includes a layer comprising metal, e.g., a metal foil such as an aluminum foil or metal fused onto a polymeric (e.g., polyethylene terephthalate (PET)) film.

In one embodiment the kit includes a spool that is stable up to a temperature of at least 100° C., and a pouch that is at least one of: moisture resistant to the extent of having a moisture vapor transmission rate (MVTR) of less than 0.002 g water/100 in²/24 hrs; hermetically sealed; metal foil containing.

In one embodiment, the present disclosure provides a packaged monofilament. The packaged monofilament is wound around a spool, and the spool with the monofilament is placed inside a foil pouch. The foil pouch is sealed under reduced pressure, or after replacing the ambient atmosphere with an inert atmosphere (e.g., nitrogen or dry air). Thus, the present disclosure provides a hermetically sealed package, such as a foil pouch, which contains monofilament wound around a spool, the foil pouch having reduced amount of moisture and/or oxygen relative to ambient conditions. Optionally, the pouch contains a single spool. Optionally, there is about 1 kg of a single length of monofilament wound around the single spool.

Also, in one embodiment, the present disclosure provides a method of forming an assembly and a kit, where the method includes: providing a composition as described herein, e.g., a monofilament composition as described herein, the composition being provided in a molten form; extruding the molten form of the composition to form a monofilament, the monofilament being formed without providing any significant orientation to the monofilament, i.e., an undrawn monofilament; winding the undrawn monofilament onto a spool to provide an assembly; and packaging the spool with monofilament wound thereon in, e.g., a foil pouch, to provide a kit. The package may be air-tight so that the monofilament is not exposed to moisture or oxidative conditions from the ambient atmosphere. The package may be, e.g., a foil pouch, in which case packaging entails placing the monofilament into the foil pouch. The monofilament may have any of the properties as described herein, e.g., composition, diameter, length, color, orientation factor, buckling strength, etc. For instance, the monofilament may be cut into a length of less than 400 meters when it is placed on a spool. As another example, the monofilament may be formed from a composition comprising a water-soluble component such as PEG (polyethyleneglycol, the additive) and a bioabsorbable polymer phase such as PDO that is essentially insoluble in water during the time that the additive dissolves in water after forming a part therefrom.

For example, in one aspect the present disclosure provides a kit comprising an assembly inside of a pouch, and optionally instructions for use. The assembly comprises a monofilament fiber as described herein, wound around a spool. When present, the instructions may disclose a use of the assembly in an additive manufacturing process. In optional embodiments, the kit may be described by one or more of the following: the spool is stable (e.g., does not melt or deform, or off-gas or leach plasticizer or other organic chemical) up to a temperature of at least 90° C.; the pouch has a moisture vapor transmission rate (MVTR) of less than 0.002 g water/100 in²/24 hrs; the pouch is a hermetically sealed pouch; the pouch comprises a metal foil.

In one embodiment, the present disclosure provides a kit where the monofilament fiber that is wound around the spool comprises a triaxial polymer of the formula M(B)₃ where M is a polymerization product of a first monomer, the first monomer selected from at least one of trimethylene carbonate and epsilon-caprolactone, and B is a polymerization product of a second monomer, the second monomer selected from at least one of glycolide, lactide and epsilon-caprolactone. Optionally, one or more (e.g., any two, or any three, or any four, or any five, etc.) of the following criteria may be used to describe the kit: the triaxial polymer is USP Class VI biocompatible; the triaxial polymer comprises a monomer content of less than 2 wt %, or less than 1.5 wt %, or less than 1 wt %, or less than 0.5 wt % monomer; M of the triaxial polymer contributes at least 5 wt % of the total weight of the M(B)₃ polymer; B comprises a polymerization product of glycolide, lactide and caprolactone; the triaxial polymer has a Tg of less than 25° C.; the monofilament fiber is undrawn; the monofilament fiber has an orientation factor of less than 50%; the monofilament fiber is essentially circular in section, and the cross section having a diameter of 1.7 mm to 2.9 mm; the monofilament fiber has a weight of 50 grams to 1,500 grams; the monofilament fiber is solid at ambient temperature but fluid at an elevated temperature, where the fluid has a MFI value of between about 2.5-30 grams per 10 minutes, where the elevated temperature is an operating temperature of an additive manufacturing process.

In one embodiment, the present disclosure provides a kit, the kit comprising a monofilament which is wound around a spool (i.e., an assembly) and contained within a pouch, and optionally instructions for using said monofilament in a method of additive manufacturing. In the assembly within the kit, the monofilament fiber comprises a polymer, the polymer selected from a linear polymer of the formula M(B)₂ and a triaxial polymer of the formula M(B)₃, wherein optionally M is a prepolymer having a Tg of less than 25° C., where M contributes at least 5 wt % of the total weight of the polymer. In another embodiment, the assembly in the kit comprises a monofilament fiber wound around a spool, where the monofilament fiber comprises a polymer, the polymer selected from a linear polymer of the formula M(B)₂ and a triaxial polymer of the formula M(B)₃, wherein optionally B is an end-graft polymer having a Tg of less than 25° C., where B contributes at least 5 wt % of the total weight of the polymer. Optionally, any one or more of the following criteria may be used to further describe either of these two kit embodiments: M is a prepolymer comprising a reaction product of a monomer selected from trimethylene carbonate and epsilon-caprolactone; B is an end-graft polymer comprising a reaction product of a monomer, where the monomer is selected from the group consisting of glycolide, lactide, trimethylene carbonate, epsilon-caprolactone and dioxanone; at least 50 molar percent of all residues in B are selected from the polymerization of monomers selected from trimethylene carbonate, epsilon-caprolactone and dioxanone; less than 100 molar percent of all residues in B are selected from the polymerization of monomers selected from glycolide and lactide. Optionally, the monofilament comprises a linear polymer of the formula M(B)₂ wherein M is a prepolymer comprising a reaction product of a monomer selected from trimethylene carbonate and epsilon-caprolactone, B is an end-graft polymer comprising a reaction product of a monomer selected from glycolide, lactide, trimethylene carbonate, epsilon-caprolactone and dioxanone, wherein at least 50 molar percent of all residues in B are selected from the polymerization of monomers selected from trimethylene carbonate, epsilon-caprolactone and dioxanone. Optionally, the monofilament comprises a linear polymer of the formula M(B)₃ wherein M is a prepolymer comprising a reaction product of a monomer selected from trimethylene carbonate and epsilon-caprolactone, B is an end-graft polymer comprising a reaction product of a monomer selected from glycolide, lactide, trimethylene carbonate, epsilon-caprolactone and dioxanone, wherein at least 50 molar percent of all residues in B are selected from the polymerization of monomers selected from trimethylene carbonate, epsilon-caprolactone and dioxanone. In these embodiments, optionally M is a homopolymer comprising a polymerization product of trimethylene carbonate; or optionally M is a homopolymer comprising a polymerization product of epsilon-caprolactone; or optionally M is a copolymer comprising a polymerization product of trimethylene carbonate and epsilon-caprolactone. In these embodiments, optionally B comprises a polymerization product of glycolide, lactide and caprolactone. Optionally, M comprises a polymer having repeating units, where at 20 mol % of the repeating units are low- or non-crystallizable, where, e.g., the low- or non-crystallizable repeating units are the polymerization product from monomer selected from epsilon-caprolactone and trimethylene carbonate. In the assembly, the polymer of the monofilament may be a USP Class VI biocompatible polymer; and/or the polymer comprises a monomer content of less than 2 wt % (or other value as disclosed herein); and/or the monofilament fiber is undrawn; and/or the monofilament fiber has an orientation factor of less than 50%; and/or the monofilament fiber has a constant diameter within the range of 1.7 mm to 2.9 mm+/−0.1 mm; and/or the monofilament fiber on the spool has a weight of 50 grams to 1,500 grams. Optionally, in the two embodiments, the monofilament is solid at ambient temperature but fluid at an elevated temperature, the fluid having a MFI value of between about 2.5-30 grams per 10 minutes, the elevated temperature being an operating temperature of an additive manufacturing process. Optionally, in the two embodiments, the monofilament has a column buckling resistance of at least 1 Newton.

The present disclosure provides the following additional exemplary embodiments of the present disclosure, in numbered form:
1) A monofilament comprising a polymer, the polymer selected from a diaxial polymer of a formula M(B)₂ and a triaxial polymer of a formula M(B)₃, wherein M is a prepolymer comprising a plurality of repeating units, optionally having a Tg of less than 25° C., where M contributes at least 5 wt % of the total weight of the polymer.
2) A monofilament comprising a polymer, the polymer selected from a diaxial polymer of a formula M(B)₂ and a triaxial polymer of a formula M(B)₃, wherein B is an end-graft polymer comprising a plurality of repeating units, optionally having a Tg of less than 25° C., where B contributes at least 5 wt % of the total weight of the polymer.
3) The monofilament of embodiments 1 or 2 wherein M is a prepolymer comprising a plurality of repeating units, the repeating units comprising a polymerization product of a monomer selected from trimethylene carbonate and epsilon-caprolactone.
4) The monofilament of embodiment 3 wherein M comprises a plurality of repeating units, the repeating units comprising a polymerization product of at least one of trimethylene carbonate and epsilon-caprolactone, the repeating units additionally comprising a polymerization product of one or both of delta-valerolactone and epsilon-decalactone.
5) The monofilament of embodiment 3 wherein M comprises a plurality of repeating units, the repeating units comprising a polymerization product of each of trimethylene carbonate, epsilon-caprolactone and glycolide.
6) The monofilament of embodiment 3 wherein M comprises a plurality of repeating units, the repeating units comprising a polymerization product of each of trimethylene carbonate, epsilon-caprolactone and lactide.
7) The monofilament of embodiments 1-6 wherein B is an end-graft polymer comprising a plurality of repeating units, the repeating units comprising a polymerization product of a monomer, where the monomer is selected from the group consisting of glycolide, lactide, trimethylene carbonate, epsilon-caprolactone and dioxanone.
8) The monofilament of embodiment 7 wherein B is an end-graft polymer comprising a plurality of repeating units, the repeating units comprising a polymerization product of each of trimethylene carbonate and glycolide.
9) The monofilament of embodiment 7 wherein B is an end-graft polymer comprising a plurality of repeating units, the repeating units comprising a polymerization product of each of trimethylene carbonate, epsilon-caprolactone and lactide.
10) The monofilament of embodiments 1-9 wherein B comprises a plurality of repeating units, and at least 50 molar percent of all the repeating units in B are selected from a polymerization of glycolide and/or lactide.
11) The monofilament of embodiments 1-10 wherein B comprises a plurality of repeating units, and less than 100 molar percent of all the repeating units in B are selected from a polymerization of glycolide and/or lactide.
12) The monofilament of embodiments 1-11 comprising a diaxial polymer of the formula M(B)₂ wherein M is a prepolymer comprising a plurality of repeating units, the repeating units comprising a polymerization product of trimethylene carbonate and/or epsilon-caprolactone, B is an end-graft polymer wherein at least 50 molar percent of all repeating units in B are selected from the polymerization product of glycolide and/or lactide, and less than 50 molar percent of all repeating units in B are selected from the polymerization of product of trimethylene carbonate and/or epsilon-caprolactone.
13) The monofilament of embodiments 1-11 comprising a triaxial polymer of the formula M(B)₃ wherein M is a prepolymer comprising a plurality of repeating units, the repeating units comprising a polymerization product of a monomer selected from trimethylene carbonate and epsilon-caprolactone, B is an end-graft polymer wherein at least 50 molar percent of all repeating units in B are selected from the polymerization of monomers selected from glycolide and lactide, and less than 50 molar percent of all repeating units in B are selected from the polymerization of monomers selected from trimethylene carbonate and epsilon-caprolactone.
14) The monofilament of embodiments 1-13 wherein M is a homopolymer from polymerization of trimethylene carbonate.
15) The monofilament of embodiments 1-13 wherein M is a homopolymer from polymerization of epsilon-caprolactone.
16) The monofilament of embodiments 1-13 wherein M is a copolymer comprising a polymerization product of trimethylene carbonate and epsilon-caprolactone.
17) The monofilament of embodiments 1-16 wherein B comprises a polymerization product of glycolide and trimethylene carbonate, optionally also including a polymerization product of lactide and/or epsilon-caprolactone.
18) The monofilament of embodiments 1-16 wherein B comprises a polymerization product of lactide and trimethylene carbonate, optionally also including a polymerization product of glycolide and/or epsilon-caprolactone.
19) The monofilament of embodiments 1-18 wherein the polymer is USP Class VI biocompatible.
20) The monofilament of embodiments 1-19 wherein the polymer comprises a monomer content of less than 2 wt %.
21) The monofilament of embodiments 1-2—wherein M comprises a polymer having repeating units, where at least 20 mol % of the repeating units are low- or non-crystallizable.
22) The monofilament of embodiment 21 wherein the low- or non-crystallizable repeating units are the polymerization product from monomer selected from epsilon-caprolactone and trimethylene carbonate.
23) The monofilament of embodiments 1-22, where
   a. M comprises a plurality of repeating units, where at least 70 mol % of the repeating units in M are a polymerization product of at least one of trimethylene carbonate and epsilon-caprolactone, and
   b. B comprises a plurality of repeating units, where at least 70 mol % of the repeating units in B are a polymerization product of at least one of glycolide and lactide.
24) The monofilament of embodiments 1-23 wherein M provides at least 10 wt % of the weight of the polymer.
25) The monofilament of embodiments 1-24 wherein B provides at least 40 wt % of the weight of the polymer.
26) The monofilament of embodiments 1-25 wherein between 1 and 20 mol % of the repeating units in M are a polymerization product of at least one of glycolide and lactide.
27) The monofilament of embodiments 1-26 wherein between 1 and 20 mol % of the repeating units in B are a polymerization product of at least one of trimethylene carbonate and epsilon-caprolactone.
28) The monofilament of embodiments 1-27 wherein M comprises repeating units from trimethylene carbonate and epsilon-caprolactone.
29) The monofilament of embodiments 1-28 wherein the polyaxial polymer has a Tg of less than 25° C.
30) The monofilament embodiments 21-29 which is undrawn.
31) The monofilament of embodiments 1-30 having an orientation factor of less than 50%.
32) The monofilament of embodiments 1-31 having a constant diameter within the range of 1.6 mm to 3.1 mm+/−0.1 mm.
33) The monofilament of embodiments 1-33 having a weight of 50 grams to 1,500 grams.
34) The monofilament of embodiments 1-34 which is solid at ambient temperature but fluid at an elevated temperature, the fluid having a MFI value of between about 2.5
30 grams per 10 minutes, the elevated temperature being an operating temperature of an additive manufacturing process.
35) The monofilament of embodiments 1-35 having a column buckling resistance of at least 1 Newton.
36) An assembly comprising a monofilament of any of embodiments 1-35 which is wound around a spool.
37) A kit comprising a monofilament according to any of embodiments 1-35 which is wound around a spool and contained within a pouch, optionally with instructions for using said monofilament or assembly in a method of additive manufacturing.
38) A method of additive manufacturing, the method comprising:
   a. melting the monofilament fiber according to any of embodiments 1-35 to provide a molten form of the fiber;
   b. depositing the molten form to provide an initial article; and
   c. cooling the initial article to room temperature to form a solid 3-dimensional article.
39) A printed article prepared from the method of embodiment 38.
40) A method of additive manufacturing, the method comprising:
   a. Installing the assembly of embodiment 36 in an additive manufacturing printer to provide a monofilament fiber in the printer;
   b. melting the monofilament fiber in the printer to provide a molten form of the fiber;
   c. depositing the molten form to provide an initial article; and
   d. cooling the initial article to room temperature to form a solid 3-dimensional article.
41) A printed article prepared from the method of embodiment 40.

### Additive Manufacturing

The monofilaments as described herein, as well as the assemblies and kits as described herein, may be used in a method of additive manufacturing. For example, in one embodiment, the present disclosure provides a method of additive manufacturing, the method comprising: melting a monofilament as descried herein to provide a molten monofilament, laying down multiple layers of the molten monofilament, one layer on top of another layer, to provide a desired shape according to additive manufacturing, and thereafter cooling the molten monofilament in the form of a desired shape to room temperature to form a solid 3-dimensional article. The method may also be described as making use of a kit of the present disclosure, where the kit may comprise, for example, a monofilament as described herein, and instructions for using said monofilament in a method of additive manufacturing. Alternatively, the kit may comprise, for example, an assembly as described herein, and instructions for using said assembly in a method of additive manufacturing.

In one embodiment, the present disclosure provides a method of additive manufacturing, the method comprising: melting a monofilament fiber as described herein to provide a molten form of the fiber; depositing the molten form to provide an initial article having a desired shape; and cooling the initial article to room temperature to form a solid 3-dimensional article.

In the method of additive manufacturing, the monofilament fiber comprises a polymer, the polymer selected from a linear polymer of the formula M(B)₂ and a triaxial polymer of the formula M(B)₃. Optionally M is a prepolymer having a Tg of less than 25° C., where M contributes at least 5 wt % of the total weight of the polymer, and/or optionally, B is an end-graft polymer having a Tg of less than 25° C., where B contributes at least 5 wt % of the total weight of the polymer. Optionally, any one or more of the following criteria may be used to further describe the method of additive manufacturing: M is a prepolymer comprising a reaction product of a monomer selected from trimethylene carbonate and epsilon-caprolactone; B is an end-graft polymer comprising a reaction product of a monomer, where the monomer is selected from the group consisting of glycolide, lactide, trimethylene carbonate, epsilon-caprolactone and dioxanone; at least 50 molar percent of all residues in B are selected from the polymerization of monomers selected from trimethylene carbonate, epsilon-caprolactone and dioxanone; less than 100 molar percent of all residues in B are selected from the polymerization of monomers selected from glycolide and lactide. Optionally, the monofilament comprises a linear polymer of the formula M(B)₂ wherein M is a prepolymer comprising a reaction product of a monomer selected from trimethylene carbonate and epsilon-caprolactone, B is an end-graft polymer comprising a reaction product of a monomer selected from glycolide, lactide, trimethylene carbonate, epsilon-caprolactone and dioxanone, wherein at least 50 molar percent of all residues in B are selected from the polymerization of monomers selected from trimethylene carbonate, epsilon-caprolactone and dioxanone. Optionally, the monofilament comprises a polyaxial polymer of the formula M(B)₃ wherein M is a prepolymer comprising a reaction product of a monomer selected from trimethylene carbonate and epsilon-caprolactone, B is an end-graft polymer comprising a reaction product of a monomer selected from glycolide, lactide, trimethylene carbonate, epsilon-caprolactone and dioxanone, wherein at least 50 molar percent of all residues in B are selected from the polymerization of monomers selected from trimethylene carbonate, epsilon-caprolactone and dioxanone. In these embodiments, optionally M is a homopolymer comprising a polymerization product of trimethylene carbonate; or optionally M is a homopolymer comprising a polymerization product of epsilon-caprolactone; or optionally M is a copolymer comprising a polymerization product of trimethylene carbonate and epsilon-caprolactone. In these embodiments, optionally B comprises a polymerization product of glycolide, lactide and caprolactone. Optionally, M comprises a polymer having repeating units, where at 20 mol % of the repeating units are low- or non-crystallizable, where, e.g., the low- or non-crystallizable repeating units are the polymerization product from monomer selected from epsilon-caprolactone and trimethylene carbonate. In the assembly, the polymer of the monofilament may be a USP Class VI biocompatible polymer; and/or the polymer comprises a monomer content of less than 2 wt % (or other value as disclosed herein); and/or the monofilament fiber is undrawn; and/or the monofilament fiber has an orientation factor of less than 50%; and/or the monofilament fiber has a constant diameter within the range of 1.7 mm to 2.9 mm+/−0.1 mm; and/or the monofilament fiber on the spool has a weight of 50 grams to 1,500 grams. Optionally, in the two embodiments, the monofilament is solid at ambient temperature but fluid at an elevated temperature, the fluid having a MFI value of between about 2.5-30 grams per 10 minutes, the elevated temperature being an operating temperature of an additive manufacturing process. Optionally, in the two embodiments, the monofilament has a column buckling resistance of at least 1 Newton.

In one embodiment, the monofilament fibers (also referred to herein simply as monofilaments) of the present disclosure may be useful in an additive manufacturing process where printing is performed by preparing multiple layers, one layer placed on top of another layer, i.e., one layer of molten polymer is laid down and then another layer of molten polymer is laid down upon some or all of the previously laid down layer (which has completely or partially solidified before the next layer is laid down). Each layer may be referred to as providing an x-y plane of the finished article, where the multiple layers together provide the z plane of the finished article. As mentioned elsewhere herein, it is sometimes the case in additive printing that the strength of the article in the z direction is less than, often significantly less than, the strength of the article in the x-y direction. In other words, the layers do not hold together as well in the z direction as does a layer in the x-y direction. This problem becomes particularly pronounced when the x-y plane is formed from a relatively large amount of polymer, so that it takes a long time to completely print a layer in the x-y direction. In this case, the part of the x-y plane that is initially printed may have totally solidified by the time the part of the x-y plane that it finally printed is completed. Thus, when the next layer is laid down (deposited on the previously laid down layer), the molten polymer is laid down upon cool, completely solidified polymer and does not adhere well to that previously laid down layer. The present disclosure addresses this problem by providing monofilament fibers having thermal and crystallization properties (based on the selection of the repeating units in M and B), that advantageously allow adjacent layers to adhere strongly to one another (as measured by, e.g., an Ultimate Stress test), even when there is a relatively long time (referred to herein as the Pause Time) between when molten polymer is laid down on the initially formed portion of the underlying x-y plane, and when that initially formed portion of the underlying x-y plane was created. In one embodiment, printing by additive manufacturing according to the present disclosure deposits molten polymer (from monofilament) onto a non-crystallized surface of the layer that has been laid down immediately previously.

In one embodiment, the present disclosure provides printed articles where the Ultimate Stress between x-y layers is effectively unaffected by the duration of the Pause Time, at least over a Pause Time period of up to 1 minute. Thus, even when the printed part (also referred to herein as the article) has an extensive x-y plane, so that complete or significant cooling of at least a portion of the x-y plane occurs before an adjacent x-y plane is laid down, the monofilaments of the present disclosure provide for consistent adhesion between these adjacent x-y planes when used in an additive manufacturing process. In one embodiment, the strength of a printed part in the z-direction is not more than +/−10% over a Pause Time of 60 seconds, e.g., the strength does not vary (e.g., drop) by more than 10% compared to a Pause Time of only a few seconds. Compared to, e.g., PLA (polylactide) or polyglycolide monofilaments, or copolymers of lactide and glycolide (PLGA), the monofilaments of one embodiment of the present disclosure which are made from polyaxial polymers as described herein increase the working time that is available during an additive manufacturing printing process, so that variation in working time has minimal impact on the strength of the printed part. In one embodiment, the Ultimate Stress of a printed part in the z-direction is essentially the same (within 10%) as the Ultimate Stress in the x-y direction, at least when the Pause Time was zero seconds in forming the printed part. Thus, even when there is no significant Pause Time, the monofilaments of the present disclosure made from polyaxial polymers provide printed parts having strength (as measured by Ultimate Stress) in the z direction that is essentially the same as the strength in the x-y plane.

In one embodiment, the present disclosure provides a printed part wherein the Ultimate Stress of the part in the z direction (also referred to as the height build direction) is within 20%, or within 15%, or within 10%, or within 5% of the Ultimate Stress of the printed part as measured in the x-y direction. This is a significant benefit since the additive manufacturing printing process inherently includes time gaps between the addition of x-y layers, and printing larger items or multiple parts via a single layer at a time results in increasing layer addition times. In order to enhance printed part strength consistency and increase mechanical isotropy, increased working time allowance between layers is critically needed and provided by the present disclosure.

The following are, succinctly stated, some of the exemplary embodiments of the present disclosure:
1) A monofilament comprising a linear polymer of the formula M(B)₂ wherein M comprises a polymer having a Tg of less than 25° C. which contributes at least 5 wt % of the total weight of the M(B)₂ polymer, and B is an end-graft polymer comprising a plurality of repeating units.
2) The monofilament of embodiment 1 wherein B comprises a polymer having repeating units, where at least 20 mol % of the repeating units are low- or non-crystallizable.
3) A monofilament comprising a linear polymer of the formula M(B)₂ wherein B comprises a polymer having a Tg of less than 25° C. which contributes at least 5 wt % of the total weight of the M(B)₂ polymer, and M is a prepolymer comprising a plurality of repeating units.
4) The monofilament of embodiment 3 wherein M comprises a polymer having repeating units, where at least 20 mol % of the repeating units are low- or non-crystallizable.
5) A monofilament comprising a triaxial polymer of the formula M(B)₃ wherein M comprises a polymer having a Tg of less than 25° C. which contributes at least 5 wt % of the total weight of the M(B)₃ polymer.
6) The monofilament of embodiment 5 wherein B comprises a polymer having repeating units, where at least 20 mol % of the repeating units are low- or non-crystallizable.
7) A monofilament comprising a triaxial polymer of the formula M(B)₃ wherein B comprises a polymer having a Tg of less than 25° C. which contributes at least 5 wt % of the total weight of the M(B)₃ polymer.
8) The monofilament of embodiment 7 wherein M comprises a polymer having repeating units, where at least 20 mol % of the repeating units are low- or non-crystallizable.
9) A monofilament comprising a linear polymer of the formula M(B)₂ wherein B comprises a polymer having repeating units, where at least 20 mol % of the repeating units are low- or non-crystallizable.
10) The monofilament of embodiment 9 wherein M comprises a polymer having a Tg of less than 25° C. which contributes at least 5 wt % of the total weight of the M(B)₂ polymer.
11) A monofilament comprising a linear polymer of the formula M(B)₂ wherein M comprises a polymer having repeating units, where at least 20 mol % of the repeating units are low- or non-crystallizable.
12) The monofilament of embodiment 11 wherein B comprises a polymer having a Tg of less than 25° C. which contributes at least 5 wt % of the total weight of the M(B)₂ polymer.
13) A monofilament comprising a triaxial polymer of the formula M(B)₃ wherein B comprises a polymer having repeating units, where at least 20 mol % of the repeating units are low- or non-crystallizable.
14) The monofilament of embodiment 13 wherein M comprises a polymer having a Tg of less than 25° C. which contributes at least 5 wt % of the total weight of the M(B)₃ polymer.
15) A monofilament comprising a triaxial polymer of the formula M(B)₃ wherein M comprises a polymer having repeating units, where at least 20 mol % of the repeating units are low- or non-crystallizable.
16) The monofilament of embodiment 15 wherein B comprises a polymer having a Tg of less than 25° C. which contributes at least 5 wt % of the total weight of the M(B)₃ polymer.
17) The monofilament of any of embodiments 1-16 wherein M comprises a polymer selected from the group consisting of poly(trimethylene carbonate), poly(lactide) and poly(trimethylene carbonate-co-lactide).
18) The monofilament of any of embodiments 1-16 wherein M comprises a polyether, e.g., poly(ethylene oxide) or a polyester, e.g., polyethylene succinate or polypropylene succinate.
19) The monofilament of any of embodiments 1-16 wherein the at least 20 mol % of low- or non-crystallizable repeating units are residues from the polymerization of monomers selected from CAP and TMC.
20) The monofilament of embodiment 19 wherein the at least 20 mol % is less than 100 mol %.
21) The monofilament of embodiment 19 wherein the at least 20 mol % is less than 90 mol %, i.e., 20-90 mol %.
22) The monofilament of embodiment 19 wherein the at least 20 mol % is less than 80 mol %, i.e., 20-80 mol %.
23) The monofilament of embodiment 19 wherein the low- or non-crystallizable repeating units are residues from the polymerization of monomers selected from lactide, glycolide and polydioxanone.
24) The monofilament of any of embodiments 1-16 wherein B comprises residues selected from the polymerization of monomers selected from glycolide, lactide, TMC, CAP and dioxanone.
25) The monofilament of embodiment 24 wherein at least 50% of the residues in B are selected from the polymerization of monomers selected from TMC, CAP and dioxanone.
26) The monofilament of embodiment 24 wherein residue selected from the polymerization of glycolide and lactide contribute less than 100% of the residues in B.
27) The monofilament of any of embodiments 1-26 which is solid at ambient temperature but fluid with a MFI value of between about 2.5-30 grams per 10 minute sat an elevated temperature which is the operating temperature of an additive manufacturing process.
28) The monofilament of any of embodiments 1-26 which is undrawn with an orientation factor of less than 50%.
29) The monofilament of any of embodiments 1-26 having a diameter within the range of 1-5 mm.
30) The monofilament of any of embodiments 1-26 having a column buckling resistance of at least 1 Newton.
31) A method of additive manufacturing, the method comprising
   a. melting a monofilament according to any of embodiments 1-30 to provide a molten monofilament, and
   b. cooling the molten monofilament to room temperature to form a solid 3-dimensional article.
32) A kit comprising a monofilament according to any of embodiments 1-30, and instructions for using said monofilament in a method of additive manufacturing.
33) A kit comprising an assembly as described herein, e.g., a monofilament wound around a spool, and instructions for using said assembly in a method of additive manufacturing.

The following Examples are offered by way of illustration and not by way of limitation.

### EXAMPLES

### Example 1

### Working Time Improvements of Lactide Copolymer

Additive manufacturing monofilaments were prepared from polymers X1, X2 and X3. X1 is a reference polymer; it is 100% polylactide, i.e., a homopolymer of lactide where all repeating units are the polymerization product of lactide. X2 (available from Poly-Med, Anderson, SC) is also a reference polymer, a triaxial polymer of formula M(B)₃ where M is a homopolymer of trimethylene carbonate, i.e., all the repeating units in M are formed by the polymerization of the monomer trimethylene carbonate, and B is the polymerization product of a mixture of lactide and trimethylene carbonate end graft. X3 (available from Poly-Med, Anderson, SC) is a polymer used to make monofilaments of the present disclosure, where X3 is a diaxial polymer of formula M(B)₂ where M is a plurality of repeating units, where about 88 mol % of those repeating units in M are a polymerization product of each of trimethylene carbonate and epsilon-caprolactone, and about 12 mol % of those repeating units are a polymerization product of lactide, i.e., the prepolymer M is made by polymerization of a mixture of the monomers trimethylene carbonate (TMC), epsilon-caprolactone (CAP) and lactide, with the total of TMC and CAP being about 88 mol % of the reactants. The B end graft in X3 likewise is a plurality of repeating units, in this case about 90 mol % of the repeating units in B are a polymerization product of lactide, and about 10 mol % are the polymerization product of a mixture of trimethylene carbonate and epsilon-caprolactone, i.e., the end grafts are made by polymerization of a mixture of the monomers trimethylene carbonate, epsilon-caprolactone and lactide, with lactide providing 90 mol % of the reactants.

In each case to prepare the monofilaments, ground polymer was dried to a low moisture level, typically less than 700 ppm water in the monofilament. The dried polymer was then extruded through a custom 3/4″ single screw extruder to obtain a monofilament with a diameter of 1.75 mm. Filaments were analyzed for molecular weight by dilute solution inherent viscosity (IV) at a concentration of 0.1 wt % in chloroform, and by DSC at a heating rate of 20° C./min to provide Tm (melting temperature) and ΔH_{f} (heat of fusion data). The results of the characterization are shown in Table 1, where N/A indicates data is not available.

TABLE 1
Monofilament Composition and Properties.

| Polymer | Composition/Description | IV (dL/g) | Tₘ (° C.) | ΔH_{f} (J/g) |
|---|---|---|---|---|
| X1 | 100% polylactide | 1.5 | 183 | 35.5 |
| X2 | Linear Triblock copolymer, | 3.1 | 161 | 25 |
| | M block is homopolymer | | | |
| | of trimethylene carbonate | | | |
| X3 | Linear Triblock copolymer, | 2.5 | N/A | N/A |
| | M block is terpolymer of | | | |
| | lactide, caprolactone and | | | |
| | trimethylene carbonate | | | |
| | repeat units | | | |

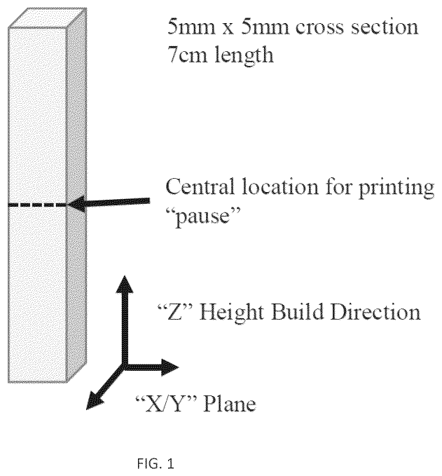

Articles in the shape of a three-dimensional orthotope (also called a right rectangular prism, rectangular cuboid, or rectangular parallelepiped, or for convenience herein, a column; see FIG. 1) having dimensions of 5 mm (x direction)×5 mm (y direction)×7 cm (z direction) were formed using the monofilaments identified in Table 1. To form the articles, FDM printing was performed using a F306 printer (Fusion3, Raleigh NC) with a Bowden Tube print head equipped with a 0.4 mm nozzle. Print conditions were modulated through the addition of a layer Pause Time (measured in seconds) at the middle of the z-direction, i.e., after printing 3.5 cm of the total of 7 cm of the z direction of the column. Parts were printed at 100% infill with no outlines and a rectilinear infill pattern. Layer pauses were modulated between 0 and 600 seconds. In the printed article, each layer of printing (i.e., each x-y plane) was printed with a thickness of 0.2 mm.

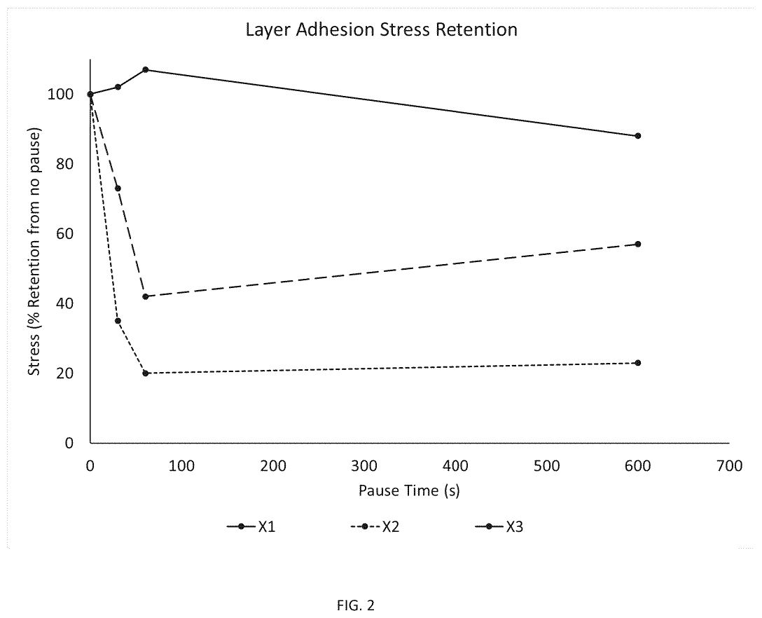

FIG. 1 shows the shape of the part that was printed, in particular a test column that was used to evaluate layer adhesion. Column samples were annealed to complete part crystallization, i.e., to achieve complete crystallization of test column”, and printed parts were evaluated for mechanical properties through a tensile test using a universal mechanical testing frame with pneumatic grips and a 5 kN load cell to determine Ultimate Stress (measured in MPa) and Ultimate Elongation (measured in % extension to break). A summary of test results is listed in Table 2 and shown graphically in FIG. 2 where the y-axis is plotted as percent retention from Pause Time equal 0 (i.e., no Pause Time).

TABLE 2
Layer Adhesion Performance of 3D Printed Columns.

| | Pause Time | Ultimate | Ultimate |
|---|---|---|---|
| Material | (s) | Stress (MPa) | Elongation (%) |
| X1 | 0 | 9.3 ± 1.0 | 5.3 ± 0.7 |
| | 30 | 6.7 ± 1.4 | 3.9 ± 0.9 |
| | 60 | 4.0 ± 0.5 | 2.1 ± 0.3 |
| | 600 | 5.4 ± 1.3 | 3.2 ± 0.9 |
| X3 | 0 | 28.8 ± 2.5 | 10.6 ± 1.3 |
| | 30 | 29.3 ± 0.8 | 10.1 ± 0.4 |
| | 60 | 30.3 ± 0.2 | 9.9 ± 0.4 |
| | 600 | 24.6 ± 5.8 | 8.0 ± 2.4 |
| X2 | 0 | 70.5 ± 16.7 | 8.2 ± 2.2 |
| | 30 | 24.8 ± 5.0 | 2.3 ± 0.4 |
| | 60 | 13.6 ± 4.2 | 1.5 ± 0.4 |
| | 600 | 18.1 ± 4.7 | 2.4 ± 0.7 |

The melting point of each material was below that of the nozzle temperature. This molten material transfers heat to the top printed layer and partially melts the top printed layer, with the extent of melting dependent on the thermal kinetics of the solidified substrate.

The Ultimate Stress data from Table 2 is plotted in FIG. 2. From FIG. 2, it can be seen that a part printed with X1 lost more than 50% of its initial breaking strength with a 30 second Pause Time as compared to a part printed with no added pauses. The Ultimate Stress of X2 was similarly reduced by 66% with a 30 second Pause Time compared to a part printed with no added pauses. In contrast, the Ultimate Stress of parts printed with X3 remained substantially consistent after either a 30 second or 60 second Pause Time, and was not significantly reduced even after a 600 second (10 minute) Pause Time. In other words, the strength of the printed part in the z-direction was observed to not vary by more than 10% over a Pause Time of 60 seconds (e.g., after a 30 second pause time, the ultimate stress varied by only 1.7% (28.8-29.3)/28.8×100=1.7%, which is less than 10 percent), and did not vary by more than 20% over a Pause Time of 600 seconds. This is a significant finding as the printing process inherently includes time gaps between the addition of layers, and printing larger items or multiple parts via a single layer at a time results in increasing layer addition times. In order to enhance printed part strength consistency and increase mechanical isotropy, increased working time allowance between layers is critically needed

TABLE 3
Mechanical Performance of 3D Printed Parts in
x/y (bed) direction and z-height direction.

| | | Ultimate |
|---|---|---|
| Material | Direction | Stress (MPa) |
| X1 | X/Y Plane | 46.9 ± 8.3 |
| | Z-height | 9.3 ± 1.0 |
| | Z-height retention | 20% |
| X3 | X/Y Plane | 27.1 ± 2.1 |
| | Z-height | 28.8 ± 2.5 |
| | Z-height retention | 107% |

Through improvements in layer adhesion, polymers can be designed for improvements in isotropy, which is desirable for predictable and uniform part performance. Ideally, materials processed through 3 dimensional printing display the same strength characteristics in the print build direction (‘Z-height’) as they do in the transverse direction (‘X/Y Plane’), indicated by a Z-height retention of 100%. A lower ratio indicates significant loss in strength resultant of poor layer adhesion mechanics. Thus, a monofilament formed from X3 provided a printed part such that the Ultimate Stress of the printed part in the z-direction (28.8 MPa) was essentially the same (within 10%) as the Ultimate Stress in the x-y direction (27.1 mPa), at least when there was no Pause Time in forming the printed part

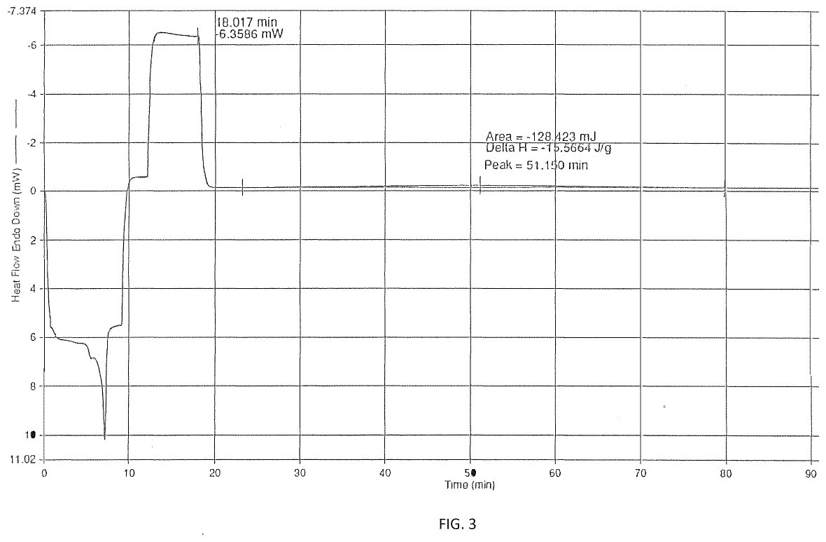

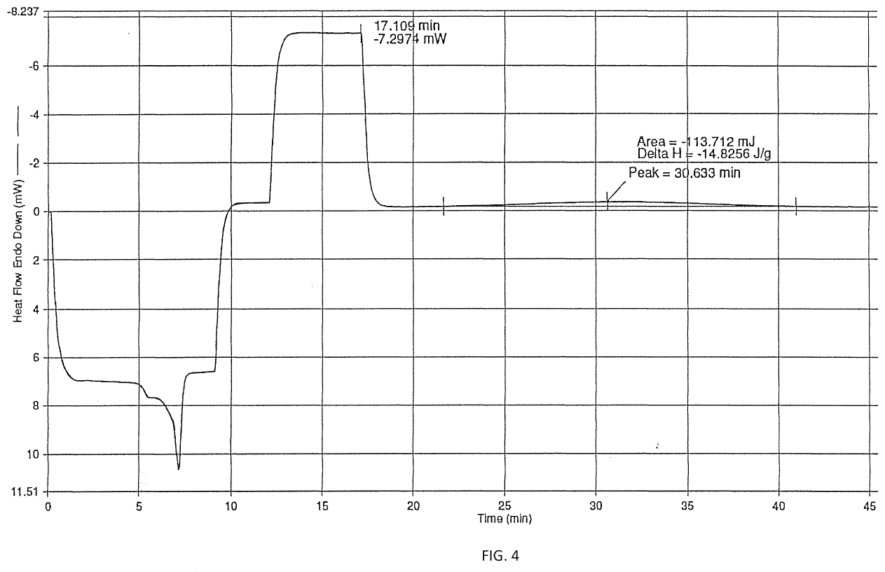

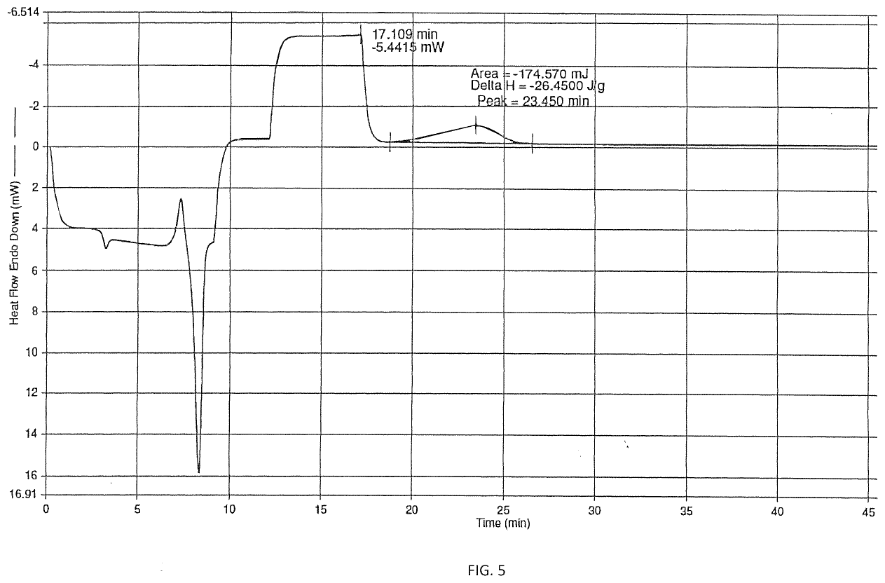

The crystallization behavior of the materials identified in Table 1 was measured by DSC. The DSC heating/cooling process began by first melting each sample at a temperature of 200° C., then the sample was cooled to a testing temperature, either 80° C. or 100° C. The testing temperature was selected to be a temperature at which the material exhibited an extended isothermal point, mimicking a working temperature. Studying the crystallization behavior at the testing temperature allows one to ascertain the time to achieve isothermal crystallization from the melt. In this study, X3 exhibited a peak crystallization event 33 minutes after cooling began with an isothermal hold at 80° C. (see FIG. 3) and a peak crystallization event 13.5 minutes after cooling began with an isothermal hold at 100° C. (see FIG. 4). Comparatively, X1 exhibited a peak crystallization event from a 100° C. isothermal hold after only 6.5 minutes (see FIG. 5), evidencing a significantly shorter working time compared to X3. In FIGS. 3-5, samples were carried through a first heating between 20° C. and 200° C. at a rate of 20° C./min, followed by a cooling ramp down to a testing temperature. Samples are treated with an isothermal hold for an extended time and analyzed for crystallization events, as shown in the FIGS. 3-5.

### Example 2

### Layer Adhesion Test Using Glycolide-Based Copolymers

Monofilaments for additive manufacturing were prepared from X4 (Poly-Med, Anderson SC, USA), which is a triaxial block copolymer M(B)₃ containing a flexible trimethylene carbonate (TMC)/caprolactone (CAP)/glycolide (GLY) (42 mol % TMC; 45 mol % CAP; 13 mol % GLY, of the repeating units in M) terpolymer central block (M) end-grafted with B, which is the polymerization product (copolymer) of a mixture of glycolide (GLY) and trimethylene carbonate (TMC) (about 89 mol % GLY and 11 mol % TMC in each B). For comparison, additive manufacturing filaments were also prepared from X5 (reference polymer), which is a random linear copolymer containing 95% glycolide and 5% I-lactide, X6 (reference polymer; Poly-Med, Anderson SC, USA), which is a triaxial block copolymer containing 86.5% glycolide and 13.5% trimethylene carbonate (the core (M) is a homopolymer formed from trimethylene carbonate and provides 13.5% of the weight of the polymer), however the end grafts (B₃, which in total contribute 86.5% of the weight of the polymer) very rapidly crystallize since they are made only from glycolide), and X7 (Poly-Med, Anderson SC, USA), which is a triaxial block copolymer where in total the end grafts provide 98% of the weight of the polymer (the end grafts comprise 93% glycolide and 5% caprolactone based on the total weight of the M(B)₃ polymer) in the end-grafts and a core which is a homopolymer of trimethylene carbonate that contributes 2% of the weight of the MB₃ polymer. The monofilaments were prepared following the procedure described in Example 1. Table 4 shows the characterization of the resulting monofilaments, in analogy with Table 1.

TABLE 4
Monofilament Composition and Properties

| Polymer | Composition/Description | IV (dL/g) | Tₘ (° C.) | ΔH_{f} (J/g) |
|---|---|---|---|---|
| X4 | Triaxial segmented block | 1.1 | 198 | 28.3 |
| | copolymer | | | |
| X5 | Linear random co-polymer | 0.9 | 213 | 62.1 |
| | of 95% glycolide, 5% l- | | | |
| | lactide | | | |
| X6 | Triaxial segmented block | 1.7 | 213 | 50.7 |
| | copolymer | | | |
| X7 | Triaxial segmented block | 0.9 | 214 | 59.0 |
| | copolymer | | | |

FDM printing was performed using a HYDRA 640 printer (Hyrel 3D, Atlanta, GA) with a modular direct drive print head equipped with a 0.4 mm nozzle. Columns were printed having the shape shown in FIG. 1 and print conditions were modulated through the addition of a Pause Time at the middle layer of the part to test the effects of time between printing layers on mechanical performance. Parts were printed at 100% infill with no outlines and a rectilinear infill pattern. Layer pauses were modulated between 0 and 600 seconds. The melting point of each material was below that of the nozzle temperature. This molten material translates heat to the top printed layer and partially melts the top layer, with the extent of melting dependent on the thermal kinetics of the solidified substrate. In the printed part, each layer was printed with a thickness of 0.2 mm.

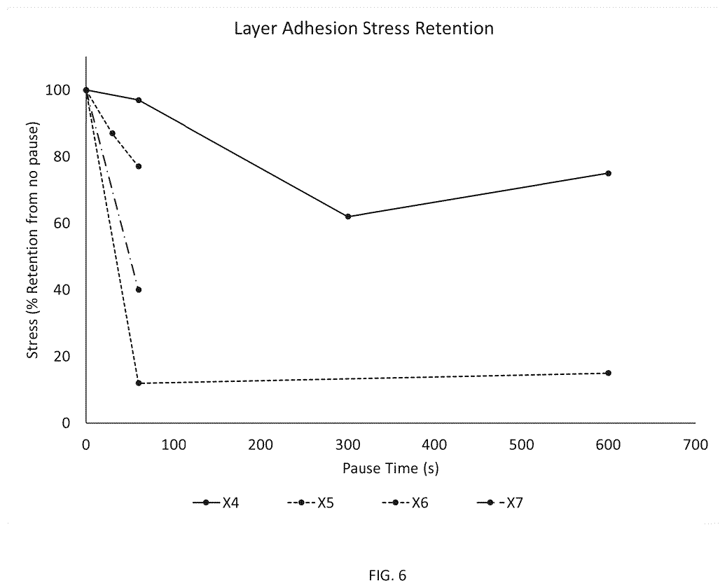

Column samples were annealed at 80° C. to achieve complete crystallization, and printed parts were evaluated for mechanical properties through a tensile test using a universal mechanical testing frame with pneumatic grips and a 5 kN load cell. A summary of test results is listed in Table 5 and FIG. 6.

TABLE 5
Performance of 3D Printed Parts.

| | Pause Time | Ultimate | Ultimate |
|---|---|---|---|
| Material | (s) | Stress (MPa) | Elongation (%) |
| X5 | 0 | 71.8 ± 15.5 | 5.3 ± 1.3 |
| | 30 | 62.0 ± 9.0 | 5.3 ± 1.0 |
| | 60 | 55.4 ± 18.0 | 5.1 ± 2.0 |
| X4 | 0 | 31.0 ± 3.3 | 1171 ± 152 |
| | 60 | 29.8 ± 3.6 | 814 ± 288 |
| | 300 | 19.2 ± 2.1 | 156 ± 118 |
| | 600 | 23.6 ± 1.1 | 34 ± 11 |
| X6 | 0 | 58.9 ± 2.6 | 33.4 ± 7.0 |
| | 60 | 7.5 ± 1.6 | 2.6 ± 0.5 |
| | 600 | 8.7 ± 3.4 | 2.4 ± 0.2 |
| X7 | 0 | 14.4 ± 4.4 | 1.3 ± 0.2 |
| | 60 | 5.7 ± 4.0 | 0.8 ± 0.2 |

The data in Table 5 and graphed in FIG. 6 indicate that X5 part average ultimate stress was reduced by 23% after 60 seconds, while X4 only had a 4% loss is strength, indicating a significant increase in working time, with minimal impact on strength properties.

Additional mechanical testing was performed on the materials of Table 4, with the results summarized in Table 6. A layer adhesion test was performed which was similar to the procedure of ASTM D1876, also known as the T-Peel Test, however a smaller than standard sample length was used, and loads were analyzed and compared with tensile strength to compare load in 2 directions. In Table 6, the average peel load over 60 mm is reported, and 5 specimens were tested and the results averaged to provide the values shown in Table 6.

TABLE 6
Performance of 3D Printed Parts.

| | Peel Load | Avg. Peel | Ultimate Tensile | % Peel Stress |
|---|---|---|---|---|
| Material | (N) | Stress (MPa) | Stress (MPa) | Conversion |
| X4 | 77.4 ± 9.9 | 7.68 | 18.50 | 42% |
| X3 | 21.3 ± 11.4 | 3.81 | 23.68 | 16% |
| X1 | 11.9 ± 3.5 | 2.12 | 46.90 | 5% |
| X7 | 37.8 ± 11.9 | 6.78 | 91.22 | 7% |

The data shown graphically in FIGS. 2 and 6 indicated that monofilament fibers formed from either X4 or X3 provided superior performance properties for use in additive manufacturing, while monofilament fibers formed from either X1 or X7 did not provide such good performance properties. In Table 6, that distinction is reflected in the ratio of the average peel stress (MPa) to the Ultimate Tensile Stress (MPa), shown as a percentage value in the right-most column of Table 6. According to the present disclosure, monofilaments forms of polymers that provide a % Peel Stress Conversion of at least 10% are advantageous in additive manufacturing processes.

X4 was also evaluated by DSC to understand the crystallization kinetics during the printing process. To perform this evaluation, monofilaments of X4 was 3D printed into a DSC sample and allowed to rest at room temperature for varying times before DSC evaluation, with DSC traces analyzed for heat of crystallization (ΔHc), heat of fusion (ΔHf), and peaks of the crystallization and melting events (Tc and Tm, respectively). Data is provided in Table 7 below.

TABLE 7
Thermal analysis of 3D printed parts after varying post-printing rest times,
the parts made from monofilaments formed from X4.

| | Rest time post printing | | | | | | |
|---|---|---|---|---|---|---|---|
| | | | | | | 1 day | |
| | | 3 hr | 6 hr | | 21 hr | 21 hr | |
| | 15 min | 12 min | 29 min | 12 hr | 42 min | 42 min | 3 day |
| T_{c} (° C.) | 102 | 87.7 | 83.1 | 64.2 | 71.9 | — | — |
| Tₘ (° C.) | 181 | 199.1 | 196.2 | 198.1 | 195.4 | 197.1 | 186.9 |
| ΔH_{c} (J/g) | 27 | 23 | 16.7 | 11.8 | 3.7 | 0 | 0 |
| ΔH_{f} (J/g) | 27.4 | 31.3 | 28.8 | 28.5 | 30.4 | 28.3 | 27.5 |
| % Crystallized | 1.5 | 26.5 | 42.0 | 58.6 | 87.8 | 100 | 100 |

In comparison to crystallization rate data for X4, X7 samples were analyzed by DSC to determine crystallization time by heating a sample from 20 to 240° C. at a rate of 20° C./minute, followed with a cooling to room temperature at the same rate. In this evaluation, X7 material recrystallized from the melt within the DSC cycle with a peak temperature of 168° C. and a peak area virtually the same as the melting peak area, meaning total polymer crystallization of X7 occurred very rapidly upon cooling the sample, suggesting it would not provide superior performance in an additive manufacturing process.

### Example 3

### Buckling Test

A column buckling test was performed as a measure of the ability of a monofilament fiber to push itself through a printer, in response to a force on the end of the fiber, i.e., can the monofilament successfully transmit the force along its length. The column buckling test evaluates the response of a filament to axial compression.

In the buckling test performed on a filamentous material, the material was placed in a vertical direction and clamped above and below the region of the filament that was tested for buckling strength. The monofilament was held in place using two lengths of Bowden tube that run along and share a single longitudinal axis, where there is a 1 cm gap between an end of one Bowden tube and an end of another Bowden tube. A length of monofilament was placed within the two Bowden tubes, providing an interstitial monofilament, such that 1 cm of interstitial monofilament which lay between the two tubes was unsupported and exposed to ambient conditions. A mechanical test frame was employed to move the two pieces of Bowden tubing closer together to thereby observe the effect of axial compression on the interstitial filament, while capturing load and displacement information during the test. The results from this test for monofilaments made from four different polymers, namely X4, X3, X1 and X7 as defined elsewhere herein, are provided in Table 8.

TABLE 8
Column Buckling Evaluation

| | | Column | Compatible | Compatible |
|---|---|---|---|---|
| | Filament | Buckling Load | with Bowden | with Direct |
| Material | Diameter (mm) | (N) | Tube? | Drive? |
| X4 | 1.73 | 2.51 ± 0.21 | No | Yes |
| X3 | 1.77 | 15.1 ± 1.6 | Yes | Yes |
| X1 | 1.75 | 32.7 ± 4.5 | Yes | Yes |
| X7 | 1.96 | 48.8 ± 7.7 | Yes | Yes |

The data from Table 8 indicate that X4 has properties that allow it to be used in a monofilament form in a direct drive printer used for additive manufacturing, since it displays a column buckling load of at least 1 N. However, because it has a column buckling load (N) of less than about 5N, it will not work well in a printer that makes use of a Bowden tube. In contrast, the relatively higher column buckling load values for X3, X1 and X7, in each case over 5 N, reflect that they have sufficient resistance to axial compression that these polymers may be used to form monofilament fibers useful in both direct drive printers and Bowden tube printers. Accordingly, in one embodiment, the monofilament of the present disclosure exhibits at least 1 Newton of resistance when tested by a column buckling test. The monofilaments of the present disclosure may be characterized as having a buckling strength of at least 1 Newton. In another embodiment, the monofilament of the present disclosure exhibits at least 1 Newton of resistance when forces are applied along the longitudinal axis of a 1 cm length of the monofilament. In one embodiment, a 1 cm length of monofilament of the present disclosure, having a width or diameter of 1.5-3.0 mm, e.g., 1.75±0.05 mm, exhibits at least 1 Newton of resistance when tested by this column buckling test. In another embodiment, a 1 cm length monofilament of the present disclosure, having a width or diameter of 1.5-3.0 mm, e.g., 1.75±0.05 mm, exhibits at least 1 Newton of resistance when forces are applied along the longitudinal axis of a 3 cm or longer length of the monofilament, where the 1 cm length is unconstrained and there is at least 1 cm of monofilament on either end of the unconstrained 1 cm of monofilament, where the unconstrained 1 cm of monofilament resists compression along its longitudinal axis.

The disclosure has been described broadly and generically herein. Each of the narrower species and subgeneric groupings falling within the generic disclosure also form part of the disclosure. This includes the generic description of the disclosure with a proviso or negative limitation removing any subject matter from the genus, regardless of whether or not the excised material is specifically recited herein.

It is also to be understood that as used herein and in the appended claims, the singular forms “a,” “an,” and “the” include plural reference unless the context clearly dictates otherwise, the term “X and/or Y” means “X” or “Y” or both “X” and “Y”, and the letter “s” following a noun designates both the plural and singular forms of that noun. In addition, where features or aspects of the invention are described in terms of Markush groups, it is intended, and those skilled in the art will recognize, that the invention embraces and is also thereby described in terms of any individual member and any subgroup of members of the Markush group, and Applicant reserves the right to revise the application or claims to refer specifically to any individual member or any subgroup of members of the Markush group.

All references disclosed herein, including patent references and non-patent references, are hereby incorporated by reference in their entirety as if each was incorporated individually.

It is to be understood that the terminology used herein is for the purpose of describing specific embodiments only and is not intended to be limiting. It is further to be understood that unless specifically defined herein, the terminology used herein is to be given its traditional meaning as known in the relevant art.

Reference throughout this specification to “one embodiment” or “an embodiment” and variations thereof means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents, i.e., one or more, unless the content and context clearly dictates otherwise. It should also be noted that the conjunctive terms, “and” and “or” are generally employed in the broadest sense to include “and/or” unless the content and context clearly dictates inclusivity or exclusivity as the case may be. Thus, the use of the alternative (e.g., “or”) should be understood to mean either one, both, or any combination thereof of the alternatives. In addition, the composition of “and” and “or” when recited herein as “and/or” is intended to encompass an embodiment that includes all of the associated items or ideas and one or more other alternative embodiments that include fewer than all of the associated items or ideas.

Unless the context requires otherwise, throughout the specification and claims that follow, the word “comprise” and synonyms and variants thereof such as “have” and “include”, as well as variations thereof such as “comprises” and “comprising” are to be construed in an open, inclusive sense, e.g., “including, but not limited to.” The term “consisting essentially of” limits the scope of a claim to the specified materials or steps, or to those that do not materially affect the basic and novel characteristics of the claimed invention.

Any headings used within this document are only being utilized to expedite its review by the reader, and should not be construed as limiting the invention or claims in any manner. Thus, the headings and Abstract of the Disclosure provided herein are for convenience only and do not interpret the scope or meaning of the embodiments.

Where a range of values is provided herein, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

For example, any concentration range, percentage range, ratio range, or integer range provided herein is to be understood to include the value of any integer within the recited range and, when appropriate, fractions thereof (such as one tenth and one hundredth of an integer), unless otherwise indicated. Also, any number range recited herein relating to any physical feature, such as polymer subunits, size or thickness, are to be understood to include any integer within the recited range, unless otherwise indicated. As used herein, the term “about” means±20% of the indicated range, value, or structure, unless otherwise indicated.

All of the U.S. patents, U.S. patent application publications, U.S. patent applications, foreign patents, foreign patent applications and non-patent publications referred to in this specification and/or listed in the Application Data Sheet, are incorporated herein by reference, in their entirety. Such documents may be incorporated by reference for the purpose of describing and disclosing, for example, materials and methodologies described in the publications, which might be used in connection with the presently described invention. The publications discussed herein and throughout the text are provided solely for their disclosure prior to the filing date of the present application. Nothing herein is to be construed as an admission that the inventors are not entitled to antedate any referenced publication by virtue of prior invention.

All patents, publications, scientific articles, web sites, and other documents and materials referenced or mentioned herein are indicative of the levels of skill of those skilled in the art to which the invention pertains, and each such referenced document and material is hereby incorporated by reference to the same extent as if it had been incorporated by reference in its entirety individually or set forth herein in its entirety. Applicant reserves the right to physically incorporate into this specification any and all materials and information from any such patents, publications, scientific articles, web sites, electronically available information, and other referenced materials or documents.

In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

Furthermore, the written description portion of this patent includes all claims. Furthermore, all claims, including all original claims as well as all claims from any and all priority documents, are hereby incorporated by reference in their entirety into the written description portion of the specification, and Applicant reserves the right to physically incorporate into the written description or any other portion of the application, any and all such claims. Thus, for example, under no circumstances may the patent be interpreted as allegedly not providing a written description for a claim on the assertion that the precise wording of the claim is not set forth in haec verba in written description portion of the patent.

The claims will be interpreted according to law. However, and notwithstanding the alleged or perceived ease or difficulty of interpreting any claim or portion thereof, under no circumstances may any adjustment or amendment of a claim or any portion thereof during prosecution of the application or applications leading to this patent be interpreted as having forfeited any right to any and all equivalents thereof that do not form a part of the prior art.

Other nonlimiting embodiments are within the following claims. The patent may not be interpreted to be limited to the specific examples or nonlimiting embodiments or methods specifically and/or expressly disclosed herein. Under no circumstances may the patent be interpreted to be limited by any statement made by any Examiner or any other official or employee of the Patent and Trademark Office unless such statement is specifically and without qualification or reservation expressly adopted in a responsive writing by Applicant.

What is claimed is:

1. A kit comprising an assembly inside of a pouch, the assembly comprising a monofilament fiber wound around a spool, the monofilament fiber comprising a polyaxial polymer of a formula M(B)₂ or M(B)₃, where:
a) M is a copolymer comprising a plurality of repeating units, where at least 70 mol % of the repeating units in M are a polymerization product of at least one of trimethylene carbonate and epsilon-caprolactone; and
b) B is a homopolymer or a copolymer comprising a plurality of repeating units, where at least 70 mol % of the repeating units in B are a polymerization product of at least one of glycolide and lactide;
wherein the monofilament fiber is solid at ambient temperature but fluid at an elevated temperature, where the fluid has a MFI value of between about 2.5-30 grams per 10 minutes, where the elevated temperature is an operating temperature of an additive manufacturing process.

2. The kit of claim 1 wherein the spool is stable up to a temperature of at least 90° C.

3. The kit of claim 1 wherein the pouch has a moisture vapor transmission rate (MVTR) of less than 0.002 g water/100 in²/24 hrs.

4. The kit of claim 1 wherein the pouch is a hermetically sealed pouch.

5. The kit of claim 1 wherein the pouch comprises multiple layers, at least one of the multiple layers comprising a metal foil.

6. The kit of claim 1 wherein the monofilament fiber comprises a monomer content of less than 2 wt %.

7. The kit of claim 1 wherein the monofilament fiber is undrawn.

8. The kit of claim 1 wherein the monofilament fiber has an orientation factor of less than 50%.

9. The kit of claim 1 wherein the monofilament fiber is essentially circular in section, and the cross section has a diameter of 1.6 mm to 3.1 mm.

10. The kit of claim 1 wherein the monofilament fiber has a weight of 50 grams to 1,500 grams.

11. The kit of claim 1 wherein the polyaxial polymer is USP Class VI biocompatible.

12. The kit of claim 1 wherein the polyaxial polymer has the formula M(B)₃.

13. The kit of claim 1 wherein the polyaxial polymer has the formula M(B)₂.

14. The kit of claim 1 wherein M provides at least 10 wt % of the weight of the polymer.

15. The kit of claim 1 wherein B provides at least 50 wt % of the weight of the polymer.

16. The kit of claim 1 wherein between 1 and 20 mol % of the repeating units in M are a polymerization product of at least one of glycolide and lactide.

17. The kit of claim 1 wherein between 1 and 20 mol % of the repeating units in B are a polymerization product of at least one of trimethylene carbonate and epsilon-caprolactone.

18. The kit of claim 1 wherein M comprises repeating units from trimethylene carbonate and epsilon-caprolactone.

19. The kit of claim 1 further comprising instructions for using the assembly in a method of additive manufacturing.

20. A 3-dimensional article prepared by a method of additive manufacturing, the method comprising:
a) melting a monofilament fiber to provide a molten form of the fiber, wherein the monofilament fiber comprises a polyaxial polymer of a formula M(B)₂ or M(B)₃, where M is a copolymer comprising a plurality of repeating units, where at least 70 mol % of the repeating units in M are a polymerization product of at least one of trimethylene carbonate and epsilon-caprolactone, and where B is a homopolymer or a copolymer and comprises a plurality of repeating units, where at least 70 mol % of the repeating units in B are a polymerization product of at least one of glycolide and lactide;
b) depositing the molten form to provide an initial article; and
c) cooling the initial article to room temperature to form a solid 3-dimensional article;
wherein the article has an x, a y and a z direction, where z is a build direction and the x and y directions are perpendicular to the z direction, the article having an ultimate stress as measured in the z-direction that is within 20% of the ultimate stress of the article as measured in either of the x or y directions.
